(19) United States
(12) Patent Application Publication
(10) Pub. No.: US 2026/0094147 A1
(43) Pub. Date: Apr. 2, 2026

(54) POWER-BASED CARD VERIFICATION HANDSHAKE

(71) Applicant: Capital One Services, LLC, McLean, VA (US)

(72) Inventors: Brian Barr, McLean, VA (US); Galen Rafferty, McLean, VA (US); Christopher Ferri, McLean, VA (US); Michael Davis, McLean, VA (US); Taylor Turner, McLean, VA (US); Owen Reinert, McLean, VA (US); Tyler Farnan, McLean, VA (US); James Schneider, McLean, VA (US)

(73) Assignee: Capital One Services, LLC, McLean, VA (US)

(21) Appl. No.: 18/903,322

(22) Filed: Oct. 1, 2024

(51) Int. Cl. G06Q 20/34

(52) U.S. Cl. CPC G06Q 20/3563; G06Q 20/341

(57) ABSTRACT

A processor of a card may determine a predetermined voltage associated with the card. The processor may receive an indication of a voltage received from a terminal, wherein the card is powered by the voltage received from the terminal. The processor may determine that the voltage received from the terminal is not equal to the predetermined voltage associated with the card. The processor may reject, based on the determination that the voltage received from the terminal is not equal to the predetermined voltage associated with the card, a request from the terminal to provide payment information associated with the card.

### BACKGROUND

Payment card products have become so universally well-known and ubiquitous that they have fundamentally changed the manner in which financial transactions and dealings are viewed and conducted in society today. Payment card products are most commonly represented by plastic or metal card-like members that are offered and provided to customers through credit card issuers (such as banks and other financial institutions). With a card, an authorized customer or cardholder is capable of purchasing services and/or merchandise without an immediate, direct exchange of cash. Data security and transaction integrity are of critical importance to businesses facilitating these transactions and to the customers. This need continues to grow as electronic transactions performed with cards constitute an increasingly large share of commercial activity. Accordingly, there is a need to provide businesses and users with an appropriate solution that overcomes current deficiencies to provide data security, authentication, and verification for cards.

### BRIEF DESCRIPTION OF THE SEVERAL VIEWS OF THE DRAWINGS

FIG. 1A illustrates an aspect of the subject matter in accordance with one embodiment.

FIG. 1B illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates a payment card in accordance with one embodiment.

FIG. 5 illustrates a transaction card component 500 in accordance with one embodiment.

FIG. 6 illustrates a sequence flow 600 in accordance with one embodiment.

FIG. 7 is a diagram of a key system according to an example embodiment.

FIG. 8 illustrates an example of a system 800 configured to operate in accordance with embodiments discussed herein.

FIG. 9 illustrates an aspect of the subject matter in accordance with one embodiment.

FIG. 10A illustrates an aspect of the subject matter in accordance with one embodiment.

FIG. 10B illustrates an aspect of the subject matter in accordance with one embodiment.

FIG. 10C illustrates an aspect of the subject matter in accordance with one embodiment.

FIG. 11 illustrates an aspect of the subject matter in accordance with one embodiment.

FIG. 12 illustrates a routine 1200 in accordance with one embodiment.

FIG. 13 illustrates an aspect of the subject matter in accordance with one embodiment.

FIG. 14 illustrates an aspect of the subject matter in accordance with one embodiment.

FIG. 15 illustrates a logic flow 1500 in accordance with one embodiment.

FIG. 16 illustrates a logic flow 1600 in accordance with one embodiment.

FIG. 17 illustrates a system 1700 in accordance with one embodiment.

### DETAILED DESCRIPTION

Embodiments disclosed herein provide techniques to securely transmit data between a card such as a payment card, transaction card, access card, or any other type of smart card. Generally, embodiments disclosed herein leverage a power-based handshake as a precondition to the card transmitting sensitive and/or secure data, such as payment data, authentication data, etc. In some embodiments, the card may store an indication of one or more predetermined threshold values (e.g., 1 millivolt (mV), 100 mVs, 1 volt, 1 ampere, 1 milliamp (mA), 1 watt, 1 milliwatt (mW), 10 milliseconds, etc.). A terminal such as an automated teller machine (ATM) or point of sale (POS) terminal may power the card using wired and/or wireless interfaces, e.g., to complete a transaction, perform authentication, gain access to a space, etc. When the terminal initially powers the card, the terminal may request information from the card. Responsive to the request, circuitry in the card may transmit, to the terminal, an indication of one or more of the predetermined threshold values. The terminal may receive the predetermined threshold value and adjust one or more of a voltage, an amperage, a resistance, a time duration, and/or a wattage supplied by the terminal to the card accordingly. For example, the initial power supplied by the terminal may be 10 mVs, and the predetermined threshold value may be 15 mVs. As such, the terminal may adjust the voltage supplied to the card from 10 mV to 15 mV.

The card may then sample or otherwise determine the voltage provided by the terminal. If the voltage provided by the terminal does not equal (and/or is not within a predetermined range of the predetermined voltage value) the predetermined voltage value, the card may reject the request and return an error code to the terminal. For example, skimming devices may be coupled to the card and the terminal when the card is inserted. The skimming devices may draw power from the terminal. Therefore, if the terminal provides the voltage requested by the card, the skimming device may use at least a portion of the voltage provided by the terminal. As such, the power received by the card may be less than the requested voltage. As such, the card may determine the skimming device is present and reject a request to provide data to the terminal. Doing so improves security of the card, terminal, and any associated data, as the skimming device or other malicious devices cannot access any data transmitted by the card to the terminal.

If, however, the voltage provided by the terminal equals (and/or is within the predetermined range of the predetermined voltage value), the voltage handshake is complete, and the card may proceed to respond to the terminal (e.g., by providing payment information, providing authentication information, providing access credentials, etc.). Embodiments are not limited in these contexts.

In some instances, card functions discussed herein may be utilized in a multi-issuer computing environment. These functions may include tap-to functions where a user may tap their card on a device, such as a mobile device, to perform a function. For example, a user may utilize their card to verify their identity, perform a payment, launch applications, log into applications, autofill a form or field, navigate to a specified web location or app on a device, unlock a door, initiate a card, verify themselves, and so forth.

The systems discussed here may enable users to perform these functions in a multi-issuer environment. Further, the systems discussed herein enable card issuers or payment providers, such as banks, to issue cards with tap-to functions to customers while maintaining high-level security. The systems discussed differ from previous solutions because they provide a single platform for multiple issuers to provide the tap-to functionality. Traditionally, each issuer must set up and maintain its own systems to provide contactless card features. This includes maintaining their own hardware, software, databases, security protocols, and so forth, which can become extremely costly for the issuer to maintain. However, the embodiments discussed enable issuers to offload much of the processing, storage, and security functionality to a neutral or central system. As will be discussed in more detail, the central system is configured to provide card features for multiple issuers while maintaining high security and data integrity. Each issuer's functionality and data may be separately managed and secured such that another issuer cannot access another issuer's data or functions. As will be discussed in more detail, these features may be provided by a switchboard system configured to process and perform each card function securely. Additional benefits for issuers may include providing a highly secure authentication option for mobile web, which typically lacks the robust authentication options available in a native application.

Further, embodiments discussed herein support tap-to mobile web experiences on both major mobile platforms (iOS®, Android®) by leveraging App Clips® and Javascript® SDK with WebNFC®. For iOS®, embodiments include providing a tap-to software development kit including functions and services to perform the operations discussed herein on the iOS® platform. The SDK may be installed into the host application, e.g., a native app or web browser app, and includes App Clip® support. The SDK provides functional support for near-field communication between the mobile device and card, installing a native app via App Clips®, and functionality to obscure data and/or portions of a display. In one example, the SDK may be configured to download and install the app from an app store, such as Apple's® App Store.

In the Android® operating system environment, embodiments include utilizing a JavaScript SDK. The JavaScript SDK may be installed into a website e.g., via source code. The JavaScript SDK also includes functions to support NFC communications between mobile devices and cards via WebNFC®. The JavaScript SDK may also include functions to provide customizable user interface (UI) capabilities and obfuscation. In embodiments, the JavaScript SDK supports websites utilizing Hypertext Transfer Protocol Secure (HTTPS) and supports the React® library. Embodiments are not limited in this manner, and UI libraries may be supported.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all operations illustrated in a logic flow may be required in some embodiments. In addition, a logic flow may be implemented by a hardware element, a software element executed by a processor, or any combination thereof. The embodiments are not limited in this context.

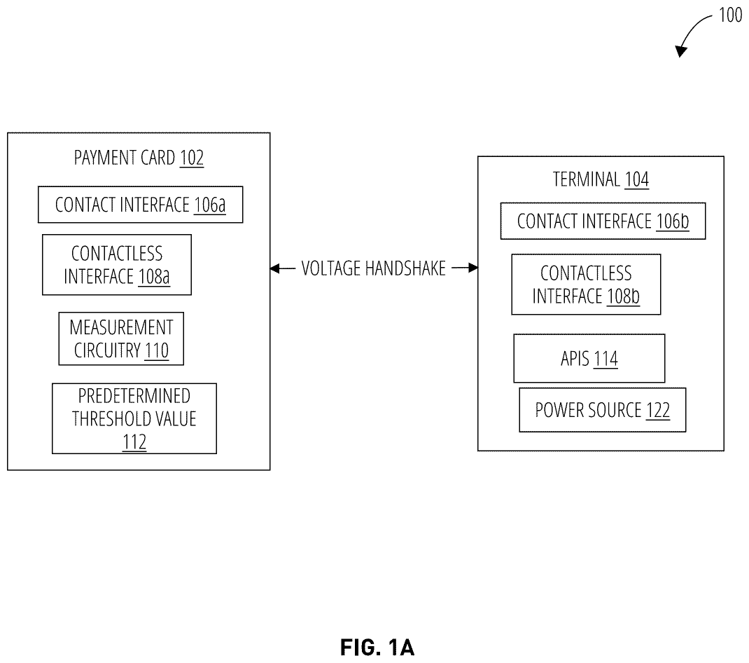

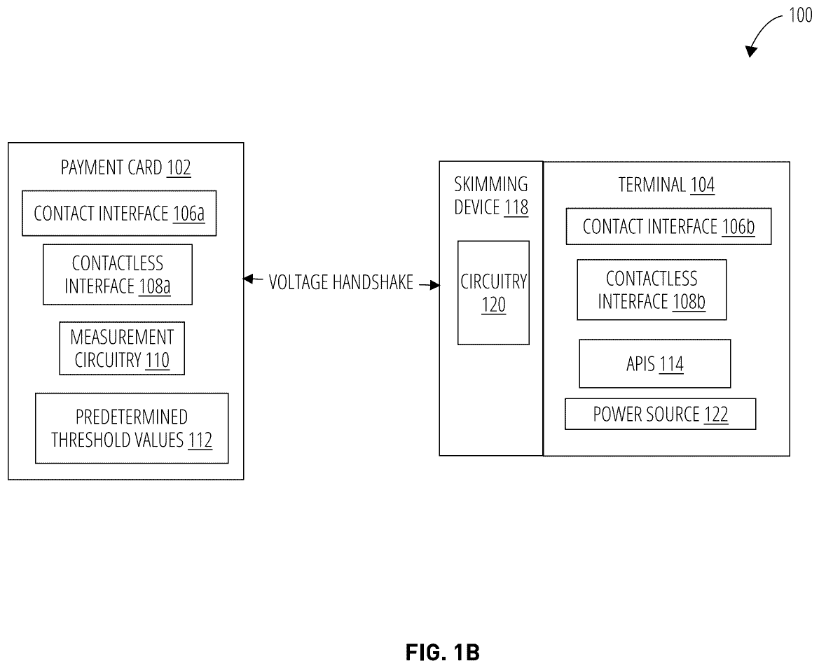

FIG. 1A illustrates a system 100 according to an example embodiment. The system 100 comprises a payment card 102 and a terminal 104. The payment card 102 (also referred to as a “card” or a “contactless card” herein) is representative of any type of card, including a credit card, debit card, gift card, transaction card, and the like. The terminal 104 is representative of any type of computing system, such as an ATM, POS terminal, a mobile device, computer, kiosk, and the like.

The payment card 102 may communicate with the terminal 104 via contact-based or contactless (e.g., wireless) communications. For example, a contact interface 106a of the payment card 102 may couple to a contact interface 106b of the terminal 104 to enable contact-based communications. Similarly a contactless interface 108a of the payment card 102 may communicate wirelessly with a contactless interface 108b of the terminal 104. Examples of wireless communications include radio frequency identification (RFID), near-field communication (NFC), Bluetooth®, and the like. The contactless interfaces 108a, 108b include circuitry (e.g., electromagnetic coils, antennas, etc.) to establish inductive coupling therebetween.

Often, malicious actors may attempt to obtain sensitive information from the payment card 102 and/or the terminal 104. Advantageously, the payment card 102 stores one or more predetermined threshold values 112 (also referred to as “predetermined voltages,” “predetermined thresholds,” “predetermined amperages,” “predetermined time durations,” “predetermined resistances,” or “predetermined power characteristics”), e.g., in circuitry and/or in a non-volatile memory, which may be used to perform a verification handshake as a precondition to performing any further operations. The predetermined threshold values 112 may include one or more predetermined voltage threshold values (e.g., in volts), one or more predetermined current threshold values (e.g., in amperes), one or more predetermined energy threshold values (e.g., in watts), one or more predetermined resistance threshold values (e.g., in Ohms), and/or one or more time duration values (e.g., a 1 second duration of power, 100 millisecond duration of power, etc.). Embodiments are not limited in these contexts.

Each of the predetermined threshold values 112 may be any non-zero value (and/or a range of values). For example, predetermined voltage threshold values stored in the predetermined threshold values 112 may be any voltage value that is greater than or equal to the minimum amount of voltage required to power the payment card 102. Examples of voltage threshold values in the predetermined threshold values 112 include 1 mV, 10 mVs, 25 mVs, 50 mVs, 100 mVs, and so on. Similarly, predetermined current values stored in the predetermined threshold values 112 may be any current value that is greater than or equal to the minimum amount of current required to power the payment card 102. Examples of current values in the predetermined threshold values 112 include 1 mA, 1 A, etc. Similarly, predetermined wattage threshold values stored in the predetermined threshold values 112 may be any wattage value that is greater than or equal to the minimum amount of wattage required to power the payment card 102. Examples of wattage threshold values in the predetermined threshold values 112 include 1 watt, 1 mW, 10 mWs, etc. Similarly, predetermined resistance threshold values stored in the predetermined threshold values 112 may be any resistance value that is permitted to power the payment card 102. Examples of resistance threshold values in the predetermined threshold values 112 include 1 Ohm, 10 milliohms, etc. As stated, the predetermined threshold values 112 may further include time durations for providing power to the payment card 102 (e.g., 100 milliseconds, 1 second, etc.).

Other types of values related to electrical characteristics may be stored in the predetermined threshold values 112. For example, maximum values (e.g., maximum voltage values, maximum wattage values, maximum resistance values, and/or maximum amperage values) may be stored in the predetermined threshold values 112. In such examples, the corresponding values sampled by the measurement circuitry 110 to determine whether the values are less than the maximum thresholds. Therefore, the use of any particular value from the predetermined threshold values 112 should not be considered limiting of the disclosure. Furthermore, a combination of different predetermined threshold values 112 may be used (e.g., a wattage threshold value, a voltage threshold value, and a current threshold value) may be used to perform power-based verification operations.

The predetermined threshold values 112 may be stored in the payment card 102 when the payment card 102 is manufactured and/or may be programmable after the card is manufactured. Multiple predetermined threshold values 112 may be stored in a payment card 102, e.g., a first predetermined threshold value 112 for the contactless interface 108a, a second predetermined threshold value 112 for the contact interface 106b, among other predetermined threshold values 112. Because the payment card 102 does not include a battery (e.g., is not self-powered), one or more power sources 122 of the terminal 104 provide electric power to the payment card 102, e.g., via the contact interfaces 106a-106b and/or the contactless interfaces 108a-108b. The power source 122 is representative of any device that provides electric power according to configurable parameters (e.g., volts, amperes, watts, etc.). Examples of power sources 122 therefore include, but are not limited to, a battery, an uninterruptible power supply (UPS), a circuit, an electric receptacle (also referred to as power outlets), an electric meter, energy storage systems, solar panels, or any other electric power source. In some embodiments, the terminal 104 is powered at least in part by the one or more power sources 122.

When the terminal 104 initially powers the payment card 102, the terminal 104 may transmit a request to the payment card 102. The request may specify to provide data. The data may include payment information (e.g., an account number, payment token, etc.) of the payment card 102, authentication information generated by the payment card 102, access control information, or any other type of sensitive data stored and/or generated by the payment card 102. In response, the payment card 102 may transmit an indication of one or more predetermined threshold values 112 to the terminal 104 (e.g., to one or more application programming interfaces (APIs) 114 of the terminal 104). For example, the indication may include a predetermined voltage value. The terminal 104 may then modify the voltage provided to power the payment card 102 by the power source 122 according to the request. For example, if the predetermined threshold value 112 is 75 mV, and the initial power provided to the payment card 102 is 50 mV, the terminal 104 may cause the power source 122 to provide 75 mV of power to the payment card 102 via the contact interfaces 106a-106b and/or the contactless interfaces 108a-108b. In addition and/or alternatively, if the predetermined threshold value 112 is 1 mA, the terminal 104 may cause the power source 122 to provide 1 mA of power to the payment card 102 via the contact interfaces 106a-106b and/or the contactless interfaces 108a-108b. In addition and/or alternatively, if the predetermined threshold value 112 is 1 mW, the terminal 104 may cause the power source 122 to provide 1 mW of power to the payment card 102 via the contact interfaces 106a-106b and/or the contactless interfaces 108a-108b.

The measurement circuitry 110 of the payment card 102 may then measure characteristics of the power signal received from the terminal 104. The characteristics may include voltage, wattage, duration of the power signal (in time), amperes, resistance, or any other characteristic of a power signal. Examples of measurement circuitry 110 include voltmeters, ammeters, multimeters, wattmeter, comparator circuits, capacitors, or any other type of circuitry that measures characteristics of the electric power provided by the terminal 104 to power the payment card 102 via the contactless interface 108a and/or the contact interface 106a. For example, the measurement circuitry 110 may determine whether the measured characteristic equals the predetermined threshold value 112 (and/or is within the range of predetermined threshold values 112, such as −1 mV to 1 mV relative to the predetermined threshold value 112). If the measured characteristic does not equal the predetermined threshold value 112 (or is outside the range of predetermined threshold values 112), the payment card 102 may reject the request and send an error code to the terminal 104. In some embodiments, the error code includes an indication that a skimming device has been maliciously coupled to the terminal 104.

For example, if the predetermined threshold value 112 is 75 mV and the voltage measured by the measurement circuitry 110 is 60 mV, the payment card 102 (e.g., the measurement circuitry 110, a processor, or other component of the payment card 102) may reject the request and send an error message to the terminal 104. Similarly, if the predetermined threshold value 112 is 75 mV and the predetermined range of voltage values is 74-76 mV and the voltage measured by the measurement circuitry 110 is 70 mV, the payment card 102 may reject the request and send an error message to the terminal 104. If, however, the voltage measured by the voltage circuitry is 75 mV, the voltage-based authentication handshake is successful, and the payment card 102 may process the request. For example, the payment card 102 may provide payment information, authentication information (e.g., a cryptogram), access information, or any other type of information to the terminal 104 based on the successful voltage-based authentication handshake.

For example, when the payment card 102 is inserted into the terminal 104, the contact interface 106a of the payment card 102 may make contact with the contact interface 106b of the terminal. Doing so causes the payment card 102 to receive power from the terminal 104 via the contact interface 106a. As stated, the terminal 104 may transmit a request to the payment card 102 after the card is powered. The payment card 102 may then provide an indication of one or more predetermined threshold values 112 to the APIs 114 of the terminal 104 via the contact interfaces 106a, 106b.

The terminal 104 may receive the indication of the one or more predetermined threshold values 112, and cause the power source 122 to modify the power supplied to the payment card 102 via the contact interfaces 106a, 106b to match the requested predetermined threshold value 112. For example, the terminal 104 may cause the power source 122 to modify one or more of the voltage, amperage, and/or current of the power supplied. For example, if the one or more predetermined threshold values 112 includes a voltage value, the measurement circuitry 110 may then determine whether the voltage received via the contact interface 106a equals the predetermined threshold value 112 (and/or is within the range of predetermined threshold values 112). If the voltage measured by the measurement circuitry 110 is not equal to the predetermined threshold value 112 (and/or is not within the range of predetermined threshold values 112), the payment card 102 may reject the request. Otherwise, the voltage-based verification handshake is complete and the payment card 102 may respond to the request, e.g., by sending data to the terminal 104.

As another example, the payment card 102 may be tapped to the terminal 104 such that the payment card 102 comes within wireless communications range with the terminal (e.g., so that the contactless interface 108a may communicate with the contactless interface 108b). Doing so causes the payment card 102 to receive power from the terminal 104 via the contactless interface 108a, e.g., using inductive coupling. As stated, the terminal 104 may transmit a request to the payment card 102 after the card is powered, e.g., via NFC. The payment card 102 may then provide an indication of one or more predetermined threshold values 112 to the APIs 114 of the terminal 104 via the contactless interfaces 108a, 108b (e.g., via NFC).

The terminal 104 may receive the indication of the one or more predetermined threshold values 112, and cause the power source 122 to modify a characteristic (e.g., wattage, amperage, voltage, resistance, time duration, etc.) of a signal supplied to the payment card 102 via the contactless interface 108b to match the requested predetermined threshold value 112. For example, if the one or more predetermined threshold values 112 includes an amperage value, measurement circuitry 110 may then determine whether the amperage of the signal received via the contactless interface 108a equals the predetermined threshold value 112 (and/or is within the range of predetermined threshold values 112). If the amperage measured by the measurement circuitry 110 is not equal to the predetermined threshold value 112 (and/or is not within the range of predetermined threshold values 112), the payment card 102 may reject the request, e.g., by sending an error code via NFC. The error code may indicate the presence of a skimming device. Otherwise, the amperage-based verification handshake is complete and the payment card 102 may respond to the request, e.g., by sending data to the terminal 104 via NFC.

In some embodiments, the payment card 102 transmits the one or more predetermined threshold values 112 as a one-time password. In some embodiments, the payment card 102 encrypts the one or more predetermined threshold values 112 using a key, where the terminal 104 has a corresponding key to decrypt the encrypted one or more predetermined threshold values 112. In some embodiments, the payment card 102 writes an indication of the one or more predetermined threshold values 112 at one or more predetermined locations in a message, where the terminal 104 knows the corresponding locations (and/or an offset thereto) in the message to extract the one or more predetermined threshold values 112. Embodiments are not limited in these contexts.

Although depicted as including both contact interface 106a and contactless interface 108a, in some embodiments, the payment card 102 may include only one of the contact interface 106a or contactless interface 108a. Similarly, although depicted as including both contact interface 106b and contactless interface 108b, in some embodiments, the terminal 104 may include only one of the contact interface 106a or contactless interface 108a. For example, a mobile device acting as a terminal may only include a contactless interface 108b. Embodiments are not limited in these contexts.

As stated, the use of voltage for verification should not be limiting of the disclosure, as other characteristics of a power signal received from the terminal 104 may be used to perform the verification handshake. For example, the measurement circuitry 110 may measure the rate of electric current (e.g., in amperes) of the signal received from the terminal to perform the verification handshake, where the payment card 102 stores one or more predetermined current values as predetermined threshold values 112 (in amperes) and requests the predetermined current value from the terminal 104. If the current received from the terminal 104 does not equal the predetermined current value, the payment card 102 may reject any requested operation. Similarly, the measurement circuitry 110 may measure the amount of energy used (e.g., in watts) by the payment card 102 to perform the verification handshake, where the payment card 102 stores one or more predetermined energy consumption values (in watts) and requests the predetermined energy consumption value from the terminal 104. If the power signal received from the terminal 104 does not allow the payment card 102 to consume an amount of energy that is equal to the predetermined energy consumption value, the payment card 102 may reject any requested operation. Similarly, the measurement circuitry 110 may measure the resistance of the signal received from the terminal 104. If the resistance of the signal received from the terminal is not equal to the predetermined resistance value, the payment card 102 may reject any requested operation. Similarly, the predetermined threshold values 112 may include a time duration threshold value. The measurement circuitry 110 may measure an amount of time power is received. If the amount of time is less than the time duration threshold, the payment card 102 may reject any requested operation. If, however, the amount of time is greater than the time duration threshold, the payment card 102 may permit the requested operation. Therefore, one or more of voltage-based verification, amperage-based verification, resistance-based, time-based, and/or voltage-based verification may be used to condition approval of a request. Embodiments are not limited in these contexts.

In some embodiments, the predetermined threshold values 112 may be modified. For example, the terminal 104 may send an instruction to the payment card 102 to cause the payment card 102 card to replace, update, or otherwise modify one or more of the predetermined threshold values 112 with updated versions of the predetermined threshold values 112. In some embodiments, the terminal 104 receives the different predetermined threshold values 112 from a server, user input, or from a local data store. Embodiments are not limited in these contexts.

FIG. 1B illustrates an example of using a power-based card verification handshake, according to one embodiment. As shown, a malicious actor may couple a skimming device 118 to the terminal 104 such that circuitry 120 of the skimming device 118 can access information stored in a card such as payment card 102 when the card is inserted into the terminal 104 (e.g., to make contact between the contact interface 106a and contact interface 106b).

As stated, after the payment card 102 is inserted into the terminal 104, the payment card 102 may transmit an indication of one or more predetermined threshold values 112 to the terminal 104, e.g., to one or more of the APIs 114. The terminal 104 may then cause the power source 122 to modify one or more characteristics of the power provided to the payment card 102 via the contact interface 106b to match the requested predetermined threshold value 112. Because the skimming device 118 is powered at least in part by the terminal 104, at least a portion of the power supplied by the terminal 104 is consumed by the skimming device 118. Therefore, the payment card 102 may sample the power received from the terminal 104 before communicating further with the terminal 104.

For example, if the predetermined threshold value 112 is 10 mV, the power source 122 may output a 10 mV signal via the contact interface 106b. However, the skimming device 118 may consume 2 mV of the 10 mV supplied by the terminal 104. Therefore, the measurement circuitry 110 of the payment card 102 may detect 8 mV of voltage. Because the voltage detected by the measurement circuitry 110 does not equal the predetermined threshold value 112 (and/or is not within a predetermined tolerance range of the predetermined threshold value 112), the payment card 102 may reject any requests to provide data to the terminal 104. For example, the payment card 102 may refrain from providing payment information (e.g., an EMV payload, etc.), providing authentication information, etc. In some embodiments, the payment card 102 transmits an error code to the terminal 104 in response to the determination that the voltage detected by the measurement circuitry 110 does not equal the predetermined threshold value 112. In some embodiments, the error code indicates that the skimming device 118 is coupled to the terminal 104. Advantageously, doing so improves security of the payment card 102 and/or data associated with the card. Furthermore, the security of the terminal 104 is improved, as the error code may be used to identify the presence of the skimming device 118, such that the terminal 104 can be disabled until the skimming device 118 is removed. Furthermore, doing so prevents the payment card 102 from being maliciously used to provide authentication information to perform other operations. Embodiments are not limited in these contexts.

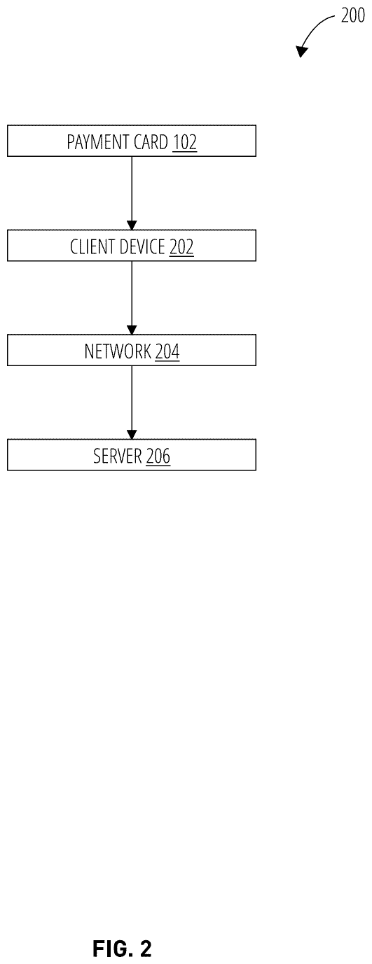

FIG. 2 illustrates a data transmission system 200 according to an example embodiment. As further discussed below, system 200 may include payment card 102, client device 202, network 204, and server 206. Although FIG. 2 illustrates single instances of the components, system 200 may include any number of components.

System 200 may include one or more payment cards 102, which are further explained herein. In some embodiments, payment card 102 may be in wireless communication, utilizing near-field communication (NFC) in an example, with client device 202.

System 200 may include client device 202, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, a payment terminal, ATM machine, or other device. Client device 202 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some embodiments, the terminal 104 is an example of the client device 202.

The client device 202 can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 202 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 202 of system 200 may execute one or more applications, such as software applications, that enable, for example, network communications with one or more components of system 200 and transmit and/or receive data.

The client device 202 may be in communication with one or more server(s) 206 via one or more network(s) 204, and may operate as a respective front-end to back-end pair with server 206. The client device 202 may transmit, for example from a mobile device application executing on client device 202, one or more requests to server 206. The one or more requests may be associated with retrieving data from server 206. The server 206 may receive the one or more requests from client device 202. Based on the one or more requests from client device 202, server 206 may be configured to retrieve the requested data from one or more databases (not shown). Based on receipt of the requested data from the one or more databases, server 206 may be configured to transmit the received data to client device 202, the received data being responsive to one or more requests.

System 200 may include one or more networks 204. In some examples, network 204 may be one or more of a wireless network, a wired network or any combination of wireless network and wired network, and may be configured to connect client device 202 to server 206. For example, network 204 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 204 may include, without limitation, telephone lines, fiber optics, IEEE Ethernet 802.3, a wide area network, a wireless personal area network, a LAN, or a global network such as the Internet. In addition, network 204 may support an Internet network, a wireless communication network, a cellular network, or the like, or any combination thereof. network 204 may further include one network, or any number of the exemplary types of networks mentioned above, operating as a stand-alone network or in cooperation with each other. network 204 may utilize one or more protocols of one or more network elements to which they are communicatively coupled. network 204 may translate to or from other protocols to one or more protocols of network devices. Although network 204 is depicted as a single network, it should be appreciated that according to one or more examples, network 204 may comprise a plurality of interconnected networks, such as, for example, the Internet, a service provider's network, a cable television network, corporate networks, such as credit card association networks, and home networks.

System 200 may include one or more servers 206. In some examples, server 206 may include one or more processors, which are coupled to memory. The server 206 may be configured as a central system, server or platform to control and call various data at different times to execute a plurality of workflow actions. Server 206 may be configured to connect to the one or more databases. The server 206 may be connected to at least one client device 202.

In some embodiments, one or more of the predetermined threshold values 112 stored in the payment card 102 can be updated. For example, a user or other entity may use the client device 202 to provide an updated voltage value. As another example, an application executing on the client device 202 may receive the updated voltage value from the server 206. The user may then tap the payment card 102 to the client device 202. In response, the application and/or client device 202 may provide an instruction to the payment card 102 to cause the payment card 102 to update, replace, or otherwise store the updated voltage value as one of the predetermined threshold values 112. Embodiments are not limited in these contexts.

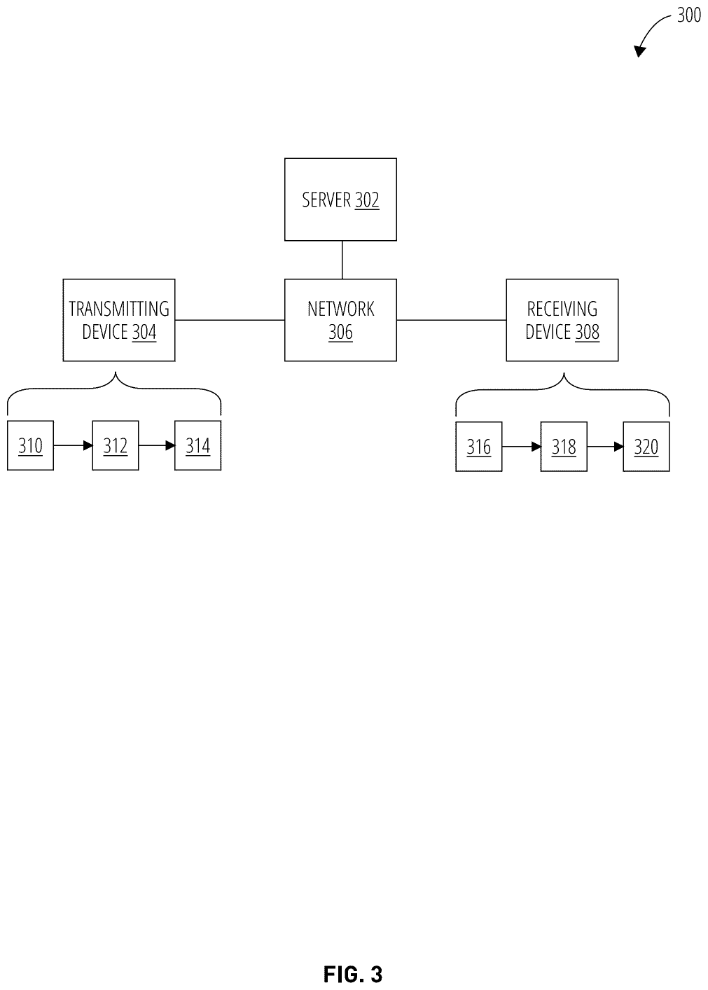

FIG. 3 illustrates a data transmission system according to an example embodiment. System 300 may include a transmitting or transmitting device 304, a receiving or receiving device 308 in communication, for example via network 306, with one or more servers 302. Transmitting or transmitting device 304 may be the same as, or similar to, client device 202 discussed above with reference to FIG. 2. Receiving or receiving device 308 may be the same as, or similar to, client device 202 discussed above with reference to FIG. 2. Network 306 may be similar to network 115 discussed above with reference to FIG. 2. Server 302 may be similar to server 206 discussed above with reference to FIG. 2. Although FIG. 3 shows single instances of components of system 300, system 300 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 3, system 300 may be configured to implement key diversification. For example, a sender and recipient may desire to exchange data (e.g., original sensitive data) via respective devices 304 and 308. As explained above, although single instances of transmitting device 304 and receiving device 308 may be included, it is understood that one or more transmitting devices 304 and one or more receiving devices 308 may be involved so long as each party shares the same shared secret symmetric key. In some examples, the transmitting device 304 and receiving device 308 may be provisioned with the same master symmetric key. Further, it is understood that any party or device holding the same secret symmetric key may perform the functions of the transmitting device 304 and similarly any party holding the same secret symmetric key may perform the functions of the receiving device 308. In some examples, the symmetric key may comprise the shared secret symmetric key which is kept secret from all parties other than the transmitting device 304 and the receiving device 308 involved in exchanging the secure data. It is further understood that both the transmitting device 304 and receiving device 308 may be provided with the same master symmetric key, and further that part of the data exchanged between the transmitting device 304 and receiving device 308 comprises at least a portion of data which may be referred to as the counter value. The counter value may comprise a number that changes each time data is exchanged between the transmitting device 304 and the receiving device 308.

System 300 may include one or more networks 306. In some examples, network 306 may be one or more of a wireless network, a wired network or any combination of wireless network and wired network, and may be configured to connect one or more transmitting devices 304 and one or more receiving devices 308 to server 302. For example, network 306 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family network, Bluetooth, NFC, RFID, Wi-Fi, and/or the like.

In addition, network 306 may include, without limitation, telephone lines, fiber optics, IEEE Ethernet 802.3, a wide area network, a wireless personal area network, a LAN, or a global network such as the Internet. In addition, network 306 may support an Internet network, a wireless communication network, a cellular network, or the like, or any combination thereof. Network 306 may further include one network, or any number of the exemplary types of networks mentioned above, operating as a stand-alone network or in cooperation with each other. Network 306 may utilize one or more protocols of one or more network elements to which they are communicatively coupled. Network 306 may translate to or from other protocols to one or more protocols of network devices. Although network 306 is depicted as a single network, it should be appreciated that according to one or more examples, network 306 may comprise a plurality of interconnected networks, such as, for example, the Internet, a service provider's network, a cable television network, corporate networks, such as credit card association networks, and home networks.

In some examples, one or more transmitting devices 304 and one or more receiving devices 308 may be configured to communicate and transmit and receive data between each other without passing through network 306. For example, communication between the one or more transmitting devices 304 and the one or more receiving devices 308 may occur via at least one of NFC, Bluetooth, RFID, Wi-Fi, and/or the like.

At block 310, when the transmitting device 304 is preparing to process the sensitive data with symmetric cryptographic operation, the sender may update a counter. In addition, the transmitting device 304 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 312, the transmitting device 304 may take the selected cryptographic algorithm, and using the master symmetric key, process the counter value. For example, the sender may select a symmetric encryption algorithm, and use a counter which updates with every conversation between the transmitting device 304 and the receiving device 308. The transmitting device 304 may then encrypt the counter value with the selected symmetric encryption algorithm using the master symmetric key, creating a diversified symmetric key.

In some examples, the counter value may not be encrypted. In these examples, the counter value may be transmitted between the transmitting device 304 and the receiving device 308 at block 312 without encryption.

At block 314, the diversified symmetric key may be used to process the sensitive data before transmitting the result to the receiving device 308. For example, the transmitting device 304 may encrypt the sensitive data using a symmetric encryption algorithm using the diversified symmetric key, with the output comprising the protected encrypted data. The transmitting device 304 may then transmit the protected encrypted data, along with the counter value, to the receiving device 308 for processing.

At block 316, the receiving device 308 may first take the counter value and then perform the same symmetric encryption using the counter value as input to the encryption, and the master symmetric key as the key for the encryption. The output of the encryption may be the same diversified symmetric key value that was created by the sender.

At block 318, the receiving device 308 may then take the protected encrypted data and using a symmetric decryption algorithm along with the diversified symmetric key, decrypt the protected encrypted data.

At block 320, as a result of the decrypting the protected encrypted data, the original sensitive data may be revealed.

The next time sensitive data needs to be sent from the sender to the recipient via respective transmitting device 304 and receiving device 308, a different counter value may be selected producing a different diversified symmetric key. By processing the counter value with the master symmetric key and same symmetric cryptographic algorithm, both the transmitting device 304 and receiving device 308 may independently produce the same diversified symmetric key. This diversified symmetric key, not the master symmetric key, is used to protect the sensitive data.

As explained above, both the transmitting device 304 and receiving device 308 each initially possess the shared master symmetric key. The shared master symmetric key is not used to encrypt the original sensitive data. Because the diversified symmetric key is independently created by both the transmitting device 304 and receiving device 308, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 304 and the receiving device 308 may be governed by symmetric requirements for how often to create a new diversification value, and therefore a new diversified symmetric key. In an embodiment, a new diversification value and therefore a new diversified symmetric key may be created for every exchange between the transmitting device 304 and receiving device 308.

In some examples, the key diversification value may comprise the counter value. Other non-limiting examples of the key diversification value include: a random nonce generated each time a new diversified key is needed, the random nonce sent from the transmitting device 304 to the receiving device 308; the full value of a counter value sent from the transmitting device 304 and the receiving device 308; a portion of a counter value sent from the transmitting device 304 and the receiving device 308; a counter independently maintained by the transmitting device 304 and the receiving device 308 but not sent between the two devices; a one-time-passcode exchanged between the transmitting device 304 and the receiving device 308; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 304 and the receiving device 308. In effect, this may create a one-time use key, such as a single-use session key.

In some embodiments, performance of the blocks 310-320 may be conditioned on the power-based handshake verification described herein. For example, the payment card 102 may provide an indication of one or more predetermined threshold values 112 to the terminal 104 (which is one of the transmitting devices 304). The terminal 104 may accept the request and cause the power source 122 to provide voltage, wattage, resistance, and/or amperage corresponding to the predetermined threshold values 112. In some embodiments, the terminal 104 causes the power source 122 to provide power corresponding to a time duration specified in one of the predetermined threshold values 112. The measurement circuitry 110 may then determine the voltage, current, resistance, time duration, and/or wattage of a signal provided by the terminal 104. If the determined voltage, current, resistance, time duration, and/or wattage is not equal to the corresponding one or more predetermined threshold values 112 (or is not within a range of the predetermined threshold values 112), the payment card 102 may refrain from performing blocks 310-320 to preserve security. If, however, the determined voltage, current, resistance, time duration, and/or wattage is equal to the corresponding predetermined threshold value 112 (or is within a range of predetermined threshold values 112), the payment card 102 may perform blocks 310-320. Embodiments are not limited in these contexts.

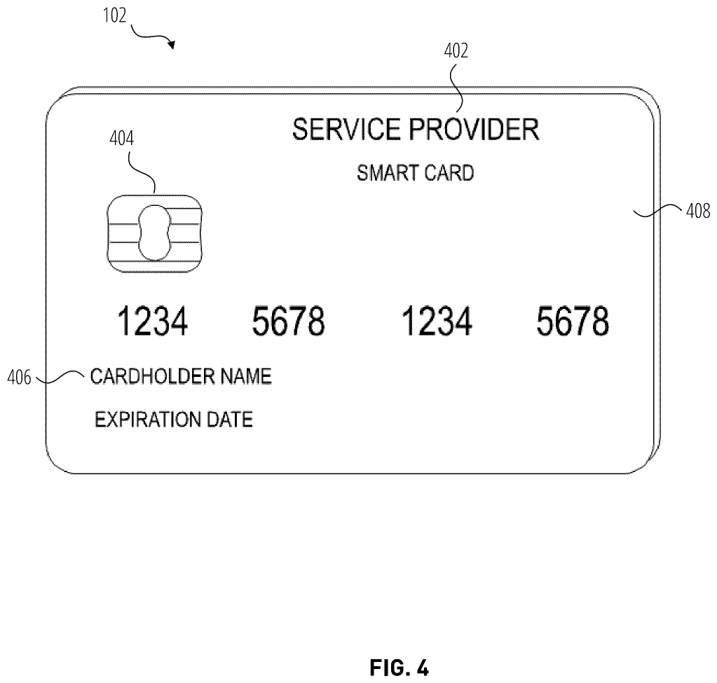

FIG. 4 illustrates an example configuration of a payment card 102, which may include a credit card, debit card, or gift card, issued by a service provider as displayed as service provider indicia 402 on the front or back of the payment card 102. In some examples, the payment card 102 is not related to a payment card, and may include, without limitation, an identification card. In some examples, the payment card 102 may include a dual interface (e.g., the contact interface 106a and contactless interface 108a) contactless payment card, a rewards card, and so forth. The payment card 102 may include a substrate 408, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the payment card 102 may have physical characteristics compliant with the ID-1 format of the ISO/IEC 7816 standard, and the transaction card may otherwise be compliant with the ISO/IEC 14443 standard. However, it is understood that the payment card 102 according to the present disclosure may have different characteristics, and the present disclosure does not require a transaction card to be implemented in a payment card.

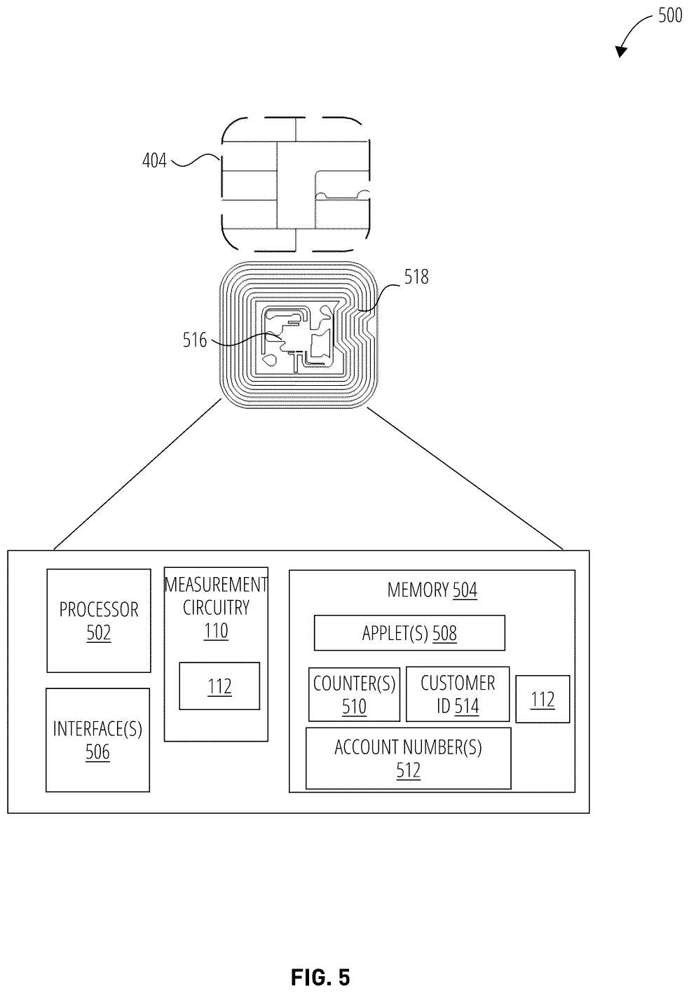

The payment card 102 may also include identification information 406 displayed on the front and/or back of the card, and a contact pad 404. The contact pad 404 is representative of the contact interface 106b of payment card 102 and may include one or more pads and be configured to establish contact with another client device, such as an ATM, terminal 104 (e.g., via contact interface 106b), a user device, smartphone, laptop, desktop, or tablet computer via transaction cards. The contact pad may be designed in accordance with one or more standards, such as ISO/IEC 7816 standard, and enable communication in accordance with the EMV protocol. The payment card 102 may also include processing circuitry, antenna and other components as will be further discussed in FIG. 5. These components may be located behind the contact pad 404 or elsewhere on the substrate 408, e.g. within a different layer of the substrate 408, and may electrically and physically coupled with the contact pad 404. The payment card 102 may also include a magnetic strip or tape, which may be located on the back of the card (not shown in FIG. 4). The payment card 102 may also include a Near-Field Communication (NFC) device coupled with an antenna (collectively the contactless interface 108a of the payment card 102) capable of communicating via the NFC protocol. Embodiments are not limited in this manner.

As illustrated in FIG. 5, the contact pad 404 of payment card 102 may include processing circuitry 516 for storing, processing, and communicating information, including a processor 502, a memory 504, the measurement circuitry 110, and one or more interface(s) 506. It is understood that the processing circuitry 516 may contain additional components, including processors, memories, error and parity/CRC checkers, data encoders, anticollision algorithms, controllers, command decoders, security primitives and tamperproofing hardware, as necessary to perform the functions described herein.

The memory 504 may be a read-only memory, write-once read-multiple memory or read/write memory, e.g., RAM, ROM, and EEPROM, and the payment card 102 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 504 may be encrypted memory utilizing an encryption algorithm executed by the processor 502 to encrypted data.

The memory 504 may be configured to store one or more applet(s) 508, one or more counter(s) 510, a customer identifier 514, one or more predetermined threshold values 112, and the account number(s) 512, which may be virtual account numbers. The one or more applet(s) 508 may comprise one or more software applications configured to execute on one or more contactless payment cards 102, such as a Java® Card applet. However, it is understood that applet(s) 508 are not limited to Java Card applets, and instead may be any software application operable on cards or other devices having limited memory. The one or more counter(s) 510 may comprise a numeric counter sufficient to store an integer. The customer identifier 514 may comprise a unique alphanumeric identifier assigned to a user of the payment card 102, and the identifier may distinguish the user of the card from other card users. In some examples, the customer identifier 514 may identify both a customer and an account assigned to that customer and may further identify the payment card 102 associated with the customer's account. As stated, the account number(s) 512 may include thousands of one-time use virtual account numbers associated with the payment card 102. An applet(s) 508 of the payment card 102 may be configured to manage the account number(s) 512 (e.g., to select an account number(s) 512, mark the selected account number(s) 512 as used, and transmit the account number(s) 512 to a mobile device for autofilling by an autofilling service.

The processor 502 and memory elements of the foregoing exemplary embodiments are described with reference to the contact pad 404, but the present disclosure is not limited thereto. It is understood that these elements may be implemented outside of the contact pad 404 or entirely separate from it, or as further elements in addition to processor 502 and memory 504 elements located within the contact pad 404.

The measurement circuitry 110 may be discrete circuitry and/or may be a component of the processor 502. The measurement circuitry 110 may include one or more predetermined threshold values 112 associated with the payment card 102.

In some examples, the payment card 102 may comprise one or more antenna(s) 518. The one or more antenna(s) 518 may be placed within the payment card 102 and around the processing circuitry 516 of the contact pad 404. For example, the one or more antenna(s) 518 may be integral with the processing circuitry 516 and the one or more antenna(s) 518 may be used with an external booster coil. As another example, the one or more antenna(s) 518 may be external to the contact pad 404 and the processing circuitry 516.

In an embodiment, the coil of payment card 102 may act as the secondary of an air core transformer. The terminal may communicate with the payment card 102 by cutting power or amplitude modulation. The contactless payment card 102 may infer the data transmitted from the terminal using the gaps in the power connection of the payment card 102, which may be functionally maintained through one or more capacitors. The payment card 102 may communicate back by switching a load on the coil of the payment card 102 or load modulation. Load modulation may be detected in the terminal's coil through interference. More generally, using the antenna(s) 518, processor 502, and/or the memory 504, the payment card 102 provides a communications interface to communicate via NFC, Bluetooth, and/or Wi-Fi communications.

As explained above, payment card 102 may be built on a software platform operable on smart cards or other devices having limited memory, such as JavaCard, and one or more applications or applets may be securely executed. Applet(s) 508 may be added to payment cards 102 to provide a one-time password (OTP) for multifactor authentication (MFA) in various mobile application-based use cases. Applet(s) 508 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 508 may be configured to encode the OTP as an NDEF type 4 well known type text tag. In some examples, NDEF messages may comprise one or more records. The applet(s) 508 may be configured to add one or more static tag records in addition to the OTP record.

In some examples, the one or more applet(s) 508 may be configured to emulate an RFID tag. The RFID tag may include one or more polymorphic tags. In some examples, each time the tag is read, different cryptographic data is presented that may indicate the authenticity of the card. Based on the one or more applet(s) 508, an NFC read of the tag may be processed, the data may be transmitted to a server, such as a server of a banking system, and the data may be validated at the server.

In some examples, the payment card 102 and server (e.g., server 206, server 302) may include certain data such that the card may be properly identified. The payment card 102 may include one or more unique identifiers (not pictured). Each time a read operation takes place, the counter(s) 510 may be configured to increment. In some examples, each time data from the payment card 102 is read (e.g., by a mobile device), the counter(s) 510 is transmitted to the server for validation and determines whether the counter(s) 510 are equal (as part of the validation) to a counter of the server.

The one or more counter(s) 510 may be configured to prevent a replay attack. For example, if a cryptogram has been obtained and replayed, that cryptogram is immediately rejected if the counter(s) 510 has been read or used or otherwise passed over. If the counter(s) 510 has not been used, it may be replayed. In some examples, the counter that is incremented on the card is different from the counter that is incremented for transactions. The contactless payment card 102 is unable to determine the application transaction counter(s) 510 since there is no communication between applet(s) 508 on the payment card 102.

In some examples, the counter(s) 510 may get out of sync. In some examples, to account for accidental reads that initiate transactions, such as reading at an angle, the counter(s) 510 may increment but the application does not process the counter(s) 510. In some examples, when the mobile device 10 is woken up, NFC may be enabled and the device may be configured to read available tags, but no action is taken responsive to the reads.

To keep the counter(s) 510 in sync, an application, such as a background application, may be executed that would be configured to detect when the device wakes up and synchronize with the server of a banking system indicating that a read that occurred due to detection to then move the counter(s) 510 forward. In other examples, Hashed One Time Password may be utilized such that a window of mis-synchronization may be accepted. For example, if within a threshold of 10, the counter(s) 510 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 510 increases in the appropriate sequence, then it may be possible to know that the user has done so.

The key diversification technique described herein with reference to the counter(s) 510, master key, and diversified key, is one example of encryption and/or decryption a key diversification technique. This example key diversification technique should not be considered limiting of the disclosure, as the disclosure is equally applicable to other types of key diversification techniques.

During the creation process of the payment card 102, two cryptographic keys may be assigned uniquely per card. The cryptographic keys may comprise symmetric keys which may be used in both encryption and decryption of data. Triple DES(3DES) algorithm may be used by EMV and it is implemented by hardware in the payment card 102. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless payment card 102 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

In some embodiments, generation of encrypted data and/or an authentication message may be conditioned on successful power-based handshake verification described herein. For example, the payment card 102 may provide an indication of one or more predetermined threshold values 112 to the terminal 104. The terminal 104 may accept the request and cause the power source 122 to provide voltage, wattage, resistance, time duration, and/or amperage corresponding to the predetermined threshold values 112. In some embodiments, the terminal 104 causes the power source 122 to provide power corresponding to a time duration specified in one of the predetermined threshold values 112. The measurement circuitry 110 may then determine the voltage, current, resistance, time duration, and/or wattage of a signal provided by the terminal 104. If the determined voltage, current, resistance, time duration, and/or wattage is not equal to the corresponding one or more predetermined threshold values 112 (or is not within a range of the predetermined threshold values 112), the payment card 102 may refrain from generating encrypted data and/or the authentication message to preserve security. If, however, the determined voltage, current, resistance, time duration, and/or wattage is equal to the corresponding predetermined threshold value 112 (or is within a range of predetermined threshold values 112), the payment card 102 may perform key diversification to generate encrypted data and/or an authentication message. Embodiments are not limited in these contexts.

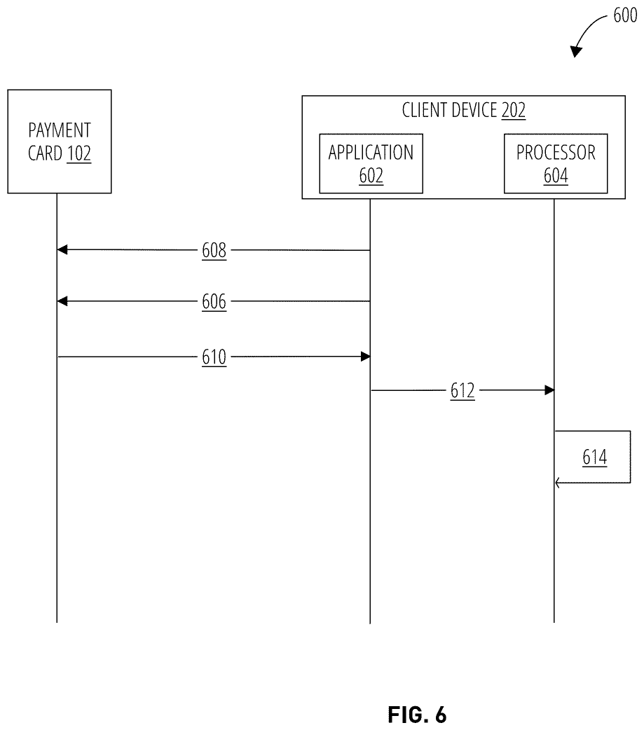

FIG. 6 is a timing diagram illustrating an example sequence for providing authenticated access according to one or more embodiments of the present disclosure. Sequence flow 600 may include payment card 102 and client device 202, which may include an application 602 and processor 604. As stated, terminal 104 is an example of client device 202.

At line 608, the application 602 communicates with the payment card 102 (e.g., after being brought near the payment card 102). Communication between the application 602 and the payment card 102 may involve the payment card 102 being sufficiently close to a card reader (not shown) of the client device 202 to enable NFC data transfer between the application 602 and the payment card 102.

At line 606, after communication has been established between client device 202 and payment card 102, payment card 102 generates a message authentication code (MAC) cryptogram. In some examples, this may occur when the payment card 102 is read by the application 602. In particular, this may occur upon a read, such as an NFC read, of a near field data exchange (NDEF) tag, which may be created in accordance with the NFC Data Exchange Format. For example, a reader application, such as application 602, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the payment card 102 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. In some embodiments, one or more predetermined threshold values 112 are included in the cryptogram. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 602 may be configured to transmit a request to payment card 102, the request comprising an instruction to generate a MAC cryptogram.

At line 610, the payment card 102 sends the MAC cryptogram to the application 602. In some examples, the transmission of the MAC cryptogram occurs via NFC, however, the present disclosure is not limited thereto. In other examples, this communication may occur via Bluetooth, Wi-Fi, or other means of wireless data communication. At line 612, the application 602 communicates the MAC cryptogram to the processor 604.

At line 614, the processor 604 verifies the MAC cryptogram pursuant to an instruction from the application 602. For example, the MAC cryptogram may be verified, as explained below. In some examples, verifying the MAC cryptogram may be performed by a device other than client device 202, such as a server of a banking system in data communication with the client device 202. For example, processor 604 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

In some embodiments, performance of sequence flow 600 may be conditioned on successful power-based handshake verification described herein. For example, the payment card 102 may provide an indication of one or more predetermined threshold values 112 to the terminal 104. The terminal 104 may accept the request and cause the power source 122 to provide voltage, wattage, resistance, time duration, and/or amperage corresponding to the predetermined threshold values 112. In some embodiments, the terminal 104 causes the power source 122 to provide power corresponding to a time duration specified in one of the predetermined threshold values 112. The measurement circuitry 110 may then determine the voltage, current, resistance, time duration, and/or wattage of a signal provided by the terminal 104. If the determined voltage, current, resistance, time duration, and/or wattage is not equal to the corresponding one or more predetermined threshold values 112 (or is not within a range of the predetermined threshold values 112), the payment card 102 may refrain from performing sequence flow 600 to preserve security. If, however, the determined voltage, current, resistance, time duration, and/or wattage is equal to the corresponding predetermined threshold value 112 (or is within a range of predetermined threshold values 112), the payment card 102 may perform sequence flow 600. Embodiments are not limited in these contexts.

As stated, in some embodiments, the predetermined threshold value 112 stored in the payment card 102 may be updated. For example, a user or other entity may use the application 602 to provide an updated voltage threshold value, an updated time duration threshold value, an updated wattage threshold value, and/or an updated amperage threshold value. As another example, the application 602 may receive the updated values from a server. The user may then tap the payment card 102 to the client device 202. In response, the application 602 and/or client device 202 may provide an instruction to the payment card 102 to cause the payment card 102 to update, replace, or otherwise store the updated values in the predetermined threshold values 112. Embodiments are not limited in these contexts.

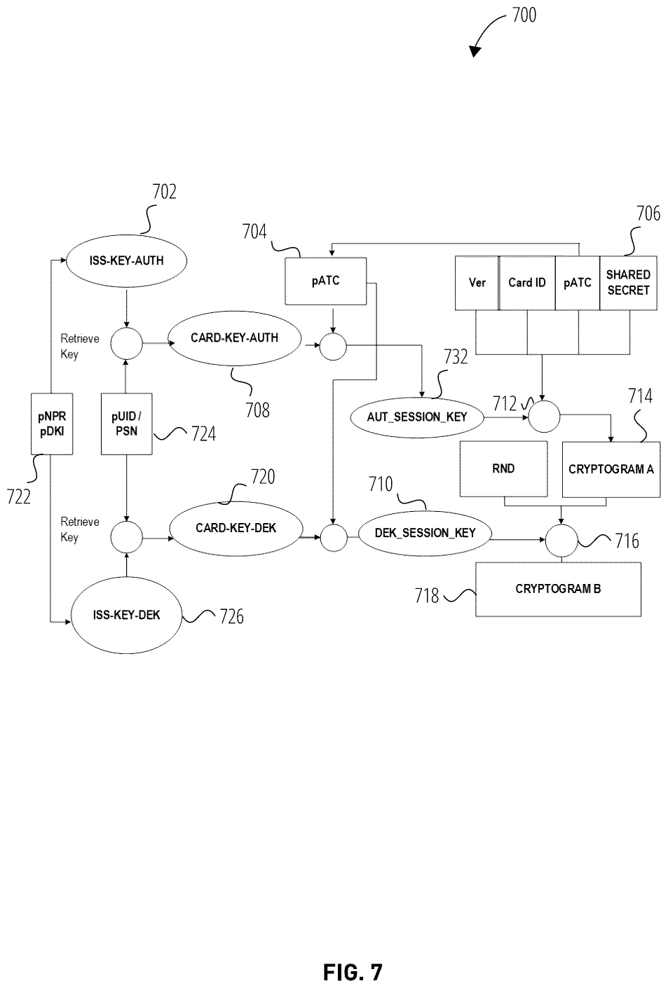

FIG. 7 illustrates a diagram of a system 700 configured to implement one or more embodiments of the present disclosure. As explained below, during the card creation process (e.g., of payment cards 102), two cryptographic keys may be assigned uniquely for each card. The cryptographic keys may comprise symmetric keys which may be used in both encryption and decryption of data. Triple DES(3DES) algorithm may be used by EMV and it is implemented by hardware in the card. By using a key diversification process, one or more keys may be derived from a master key based upon uniquely identifiable information for each entity that requires a key.

Regarding master key management, two issuer master keys 702, 726 may be required for each part of the portfolio on which the one or more applets is issued. For example, the first master key 702 may comprise an Issuer Cryptogram Generation/Authentication Key (Iss-Key-Auth) and the second master key 726 may comprise an Issuer Data Encryption Key (Iss-Key-DEK). As further explained herein, two issuer master keys 702, 726 are diversified into card master keys 708, 720, which are unique for each card. In some examples, a network profile record ID (pNPR) 522 and derivation key index (pDKI) 724, as back office data, may be used to identify which Issuer Master Keys 702, 726 to use in the cryptographic processes for authentication. The system performing the authentication may be configured to retrieve values of pNPR 722 and pDKI 724 for a card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 708 and Card-Key-Dek 720). The session keys (Aut-Session-Key 732 and DEK-Session-Key 710) may be generated by the one or more applets and derived by using the application transaction counter (pATC) 704 with one or more algorithms. To fit data into the one or more algorithms, only the 2 low order bytes of the 4-byte pATC 704 is used. In some examples, the four byte session key derivation method may comprise: F1:=PATC (lower 2 bytes)∥‘F0’∥‘00’∥PATC (four bytes) F1:=PATC (lower 2 bytes)∥‘0F’ ∥‘00’ ∥PATC (four bytes) SK: ={(ALG (MK) [F1])∥ALG (MK) [F2]}, where ALG may include 3DES ECB and MK may include the card unique derived master key.

As described herein, one or more MAC session keys may be derived using the lower two bytes of pATC 704 counter. At each tap of the card, pATC 704 is configured to be updated, and the card master keys Card-Key-AUTH 708 and Card-Key-DEK 720 are further diversified into the session keys Aut-Session-Key 732 and DEK-Session-KEY 710. pATC 704 may be initialized to zero at personalization or applet initialization time. In some examples, the pATC counter 704 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 732. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 732, as explained above. As explained above, the low order two bytes of the counter may be used to diversify for the one or more MAC session keys. As explained below, AUT-Session-Key 732 may be used to MAC data 706, and the resulting data or cryptogram A 714 and random number RND may be encrypted using DEK-Session-Key 710 to create cryptogram B or output 718 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 710 derived from the Card-Key-DEK 720. In this case, the ATC value for the session key derivation is the least significant byte of the counter pATC 704.

The format below represents a binary version example embodiment. Further, in some examples, the first byte may be set to ASCII ‘A’.

| | | | | | | |
|---|---|---|---|---|---|---|
| Message Format | | | | | | |
| 1 | 2 | 4 | | 8 | | 8 |
| 0x43 (Message Type ‘A’) | Version | pATC | | RND | | Cryptogram A (MAC) |
| Cryptogram A (MAC) | 8 bytes | | | | | |
| MAC of | | | | | | |
| 2 | 8 | 4 | 4 | | 18 bytes input data | |
| Version | pUID | pATC | Shared Secret | | | |

| | | | | | |
|---|---|---|---|---|---|
| Message Format | | | | | |
| 1 | 2 | 4 | | 16 | |
| 0x43 (Message Type ‘A’) | Version | pATC | | Cryptogram B | |
| Cryptogram A (MAC) | 8 bytes | | | | |
| MAC of | | | | | |
| 2 | 8 | 4 | 4 | | 18 bytes input data |
| Version | pUID | pATC | Shared Secret | | |
| Cryptogram B | 16 | | | | |
| Sym Encryption of | | | | | |
| 8 | 8 | | | | |
| RND | Cryptogram A | | | | |

Another exemplary format is shown below. In this example, the tag may be encoded in hexadecimal format.

| Message Format | | | | | | |
|---|---|---|---|---|---|---|
| 2 | 8 | 4 | | 8 | | 8 |
| Version | pUID | pATC | | RND | | Cryptogram A (MAC) |
| 8 bytes | | | | | | |
| 8 | 8 | 4 | 4 | | 18 bytes input data | |
| pUID | pUID | pATC | Shared Secret | | | |

| | | | | | |
|---|---|---|---|---|---|
| Message Format | | | | | |
| 2 | 8 | 4 | | 16 | |
| Version | pUID | pATC | | Cryptogram B | |
| 8 bytes | | | | | |
| 8 | | 4 | 4 | | 18 bytes input data |
| pUID | pUID | pATC | Shared Secret | | |
| Cryptogram B | 16 | | | | |
| Sym Encryption of | | | | | |
| 8 | 8 | | | | |
| RND | Cryptogram A | | | | |

The UID field of the received message may be extracted to derive, from master keys Iss-Key-AUTH 702 and Iss-Key-DEK 726, the card master keys (Card-Key-Auth 708 and Card-Key-DEK 720) for that particular card. Using the card master keys (Card-Key-Auth 708 and Card-Key-DEK 720), the counter (pATC) field of the received message may be used to derive the session keys (Aut-Session-Key 732 and DEK-Session-Key 710) for that particular card. Cryptogram B 718 may be decrypted using the DEK-Session-KEY, which yields cryptogram A 714 and RND, and RND may be discarded. The UID field may be used to look up the shared secret of the card which, along with the Ver, UID, and pATC fields of the message, may be processed through the cryptographic MAC using the re-created Aut-Session-Key to create a MAC output, such as MAC′. If MAC′ is the same as cryptogram A 714, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 732. The input data 706 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x‘80’ byte to the end of input data and 0x‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by I each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 712, data 706 is processed through the MAC using Aut-Session-Key 732 to produce MAC output (cryptogram A) 714, which is encrypted.

In order to provide additional protection against brute force attacks exposing the keys on the card, it is desirable that the MAC cryptogram 714 be enciphered. In some examples, data or cryptogram A 714 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 710. In the encryption operation 716, data or cryptogram A 714 and RND are processed using DEK-Session-Key 710 to produce encrypted data, cryptogram B 718. The data 714 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

In some embodiments, generation of encrypted data according to the techniques described in FIG. 7 (or elsewhere herein) may be conditioned on successful power-based handshake verification described herein. For example, the payment card 102 may provide an indication of one or more predetermined threshold values 112 to the terminal 104. The terminal 104 may accept the request and cause the power source 122 to provide voltage, wattage, resistance, and/or amperage corresponding to the predetermined threshold values 112. In some embodiments, the terminal 104 causes the power source 122 to provide power corresponding to a time duration specified in one of the predetermined threshold values 112. The measurement circuitry 110 may then determine the voltage, current, resistance, time duration, and/or wattage of a signal provided by the terminal 104. If the determined voltage, current, resistance, time duration, and/or wattage is not equal to the corresponding one or more predetermined threshold values 112 (or is not within a range of the predetermined threshold values 112), the payment card 102 may refrain from generating encrypted data according to FIG. 7 to preserve security. If, however, the determined voltage, current, resistance, time duration, and/or wattage is equal to the corresponding predetermined threshold value 112 (or is within a range of predetermined threshold values 112), the payment card 102 may perform key diversification to generate encrypted data according to FIG. 7. Embodiments are not limited in these contexts.

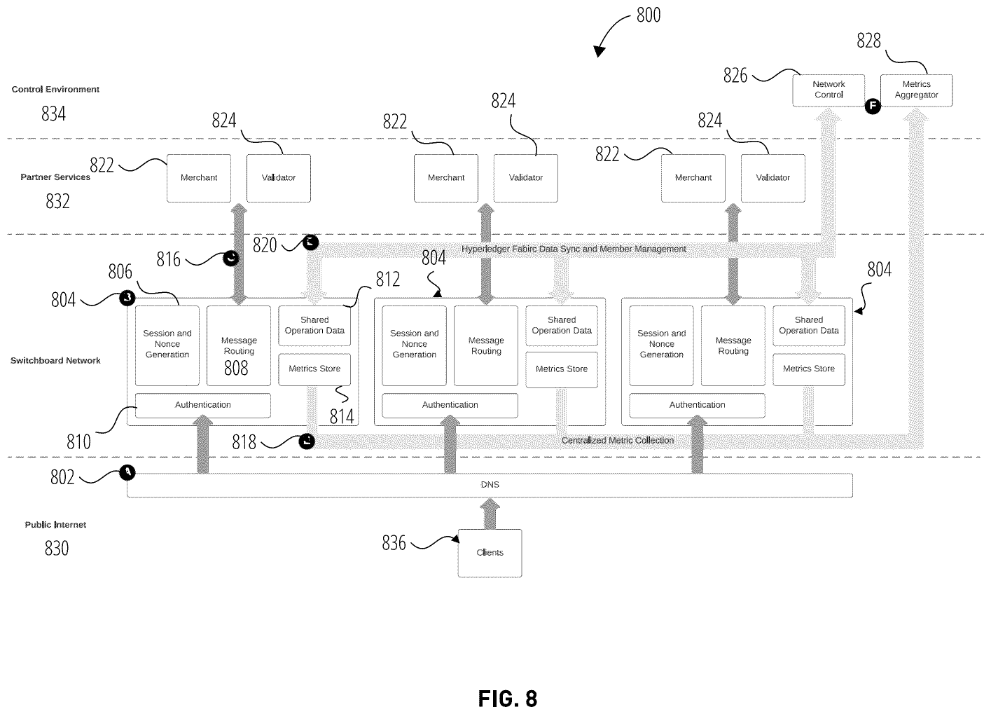

In some instances, embodiments may be implemented in a multi-issuer environment and messages are routed through a switchboard system, such as system 800. FIG. 8 illustrates an example of system 800 in accordance with the embodiments discussed herein. The system 800 includes additional devices and systems configured to enable card issuers to tap-to-card services. Specifically, system 800 enables any number of issuer systems to provide card services to their clients through a switching fabric, i.e., the switchboard system in a secure and safe manner.

In embodiments, the switchboard system includes one or more nodes 804 configured to perform routing operations. Each switchboard node 804 may include a session and nonce generator 806, a message router 808, an authentication 810, an operation data 812 store, and a metrics store 814. Further, each of the nodes may be configured the same and share configurations, but each switchboard node 804 may independently process and route messages and requests to the appropriate systems, such as the merchant systems and issuer systems. Each of the nodes 804 is configured to act as a broker of trust between an issuer system, the merchant system 822, and/or validation system 824, for example. Each switchboard node 804 is configured to route each message to the correct issuer system while maintaining data security. For example, a switchboard node 804 may route a message between an issuer system and a merchant system while the node cannot access the private data in the message.

The switchboard system may be configured as a server system with a collection of hardware, software, and networking components that work together to provide client services. Hardware components may include one or more server computers, storage devices, and network adapters. The server computers are configured to run server applications, such as those executable on each of the nodes 804. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

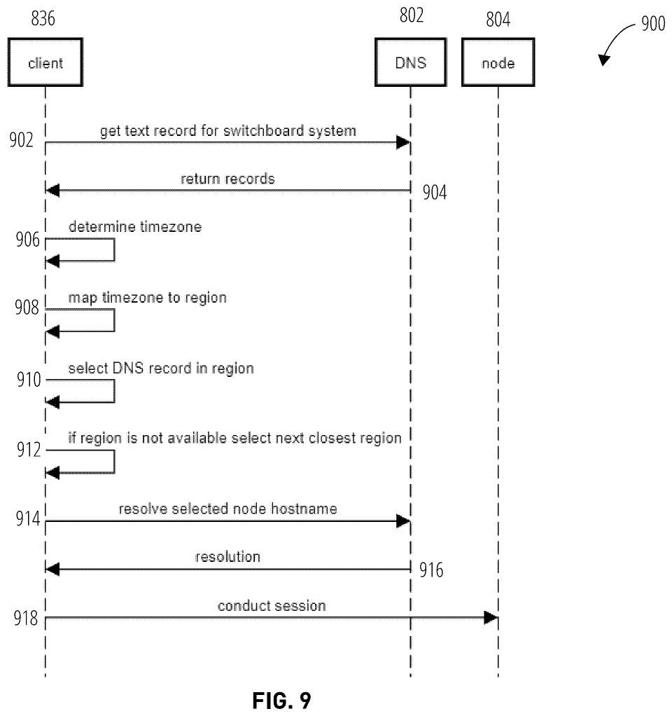

In some embodiments, the nodes 804 may operate in a cloud-based computing environment, e.g., a collection of hardware, software, and networking components that enable the delivery of cloud computing services. The switchboard nodes 804 and the computing services are delivered over the Internet and can be accessed from anywhere in the world with an Internet connection. In embodiments, client 836 may access a switchboard node 804 through Domain Name System 802 or Domain Name System (DNS). The terminal 104 and client devices 202 are examples of a client 836. The DNS 802 is a hierarchical and distributed naming system for computers, services, and other resources connected to the Internet or other networks. It associates various information with domain names assigned to each registered participant. In one example, the DNS 802 may translate a name known to software executing on a client 836 to route data to one or more of switchboard node 804 of the switchboard system. In embodiments, the DNS 802 may generate a number, such as an Internet Protocol (IP) address, an address record (A-record), or another Hostname (C-name record). FIG. 9 illustrates one example sequence 900 for a client to identify and resolve an identifier for one of the nodes 804 of the switchboard system. At a high level, the Domain Name System 802 translates known domain names to numerical Internet Protocol (IP) addresses needed for locating and identifying computer services and devices with the underlying network protocols. Clients use the global DNS system to select the best node to use, as discussed in sequence 900.

In embodiments, a client 836 communicates with the switchboard system to perform one or more of the partner services 832, such as conducting a transaction with a merchant, validating the customer, or other tap-to functions. Once client 836 identifies a switchboard node 804 and resolves an address to communicate with switchboard node 804, client 836 may send one or more messages to switchboard node 804 to authenticate and perform the operation. The switchboard node 804 includes an authentication 810 function that is configured to authenticate the client 836. In embodiments, the client 836 sends a message or authorization request to the switchboard node 804 with the following header set:
X-Sb-Api-Key: <CLIENT API KEY>
X-Sb-Dvc-Fngrprnt: Device-specific device fingerprint

The CLIENT API KEY may have the following example structure: 65535-GReyx5BuEAaE72bWbFZJfHRL8Dbt1Uum, where table 1 describes the value, name, and meaning:

TABLE 1

| Value | Name | Meaning |
|---|---|---|
| 65535 | Client ID | Individual identifier of client |
| GReyx5BuEAsE72bWbFZJfHRL8Dbt1Uum | Client Key | Randomly assigned key |

The switchboard node 804 may authorize or authenticate the client 836 or user, and the switchboard node 804 may utilize the additional components, such as the session and nonce generator 806 and message router 208, to perform the operations. Note the Validators validation systems 224 never interact with the merchant systems 222, nor vice versa. The nodes 804 broker all communication.

In embodiments, the switchboard system may utilize a hyper ledger fabric 820 to manage to synchronize the shared operation data 812 and member management across the network. The hyperledger fabric 820 is distributed ledger framework having a permissioned network model that only authorized participants can join the network and access the data that is stored on a ledger.

In embodiments, the hyperledger fabric 820 may be generated by creating one or more sets of peers, an ordering service, and a channel. Once the network is created, system 800 deploys chaincode to the network, or node 804 is permitted to access the fabric. The chaincode is the code that runs on the blockchain and executes the network control 826 and operation data 812 logic code. Once the chaincode is deployed, each of the switchboard nodes 804 is configured to invoke transactions on the blockchain to add data to the blockchain, e.g., the operational data. A switchboard node 804 or another device can query the ledger to retrieve data. The ledger is a distributed database that stores all the data added to the blockchain.

All nodes 804 keep an independently verifiable log of their actions that can be transmitted to a centralized aggregator to build a picture of overall network usage. System 800 can manage network operation data and management at a central level and have a centralized view of network use, aggregated and abstracted to the appropriate level.

FIG. 9 illustrates an example sequence 900 for a client to utilize DNS to resolve and communicate with one or more nodes of a switchboard system. The illustrated sequence 900 includes a client 836, a DNS 802, and a switchboard node 804. At 902, the sequence 902 includes the client 836 sending a request to a default DNS server for a text record switchboard. {domain}. {tld}. The text record may be preconfigured in a client app and/or client sdk. At 904, the DNS 802 returns one or more records. A DNS record structure may include the following:

```
● Root Record:
  ◯ Name: switchboard.{domain}.{tld}
  ◯ Type: TXT
  ◯ Resolution:
    ▪ {nodename_1}.{operator_a}.{region_i}.switchboard.{domain}.{tld},
    ▪ {nodename_2}.{operator_a}.{region_i}.switchboard.{domain}.{tld},
    ▪ {nodename_1}.{operator_b}.{region_ii}.switchboard.{domain}.{tld},
    ▪ {nodename_2}.{operator_b}.{region_ii}.switchboard.{domain}.{tld},
    ▪ * etc.
  ◯ Used For determining where there are active nodes
● Node Record:
  ◯ Name: {nodename}.{operator}.{region}.switchboard.{domain}.{tld}
  ◯ Type: A/AAAA or CNAME
  ◯ Resolution: Actual node hostname or IP
  ◯ Used For: communicating with a node 804
```

In embodiments, the client 836 may determine the current timezone at 906. For example, the client app or sdk may utilize a get current timezone function, such as in JavaScript: Intl.Date TimeFormat( ).resolvedOptions( ).timeZone). Embodiments are not limited in this manner, and the app or sdk may determine the timezone via another/different function call. At 908, the client 836 is configured to map the timezone to a region or short-version identifier of the region. One example includes America/New_York->na-e. The region may be based on DNS names, for example. Table 2 illustrates a few examples of timezone mappings to regions:

TABLE 2

| Timezone | Region | Short Version |
|---|---|---|
| America/New_York | North America / East | na-e |
| America/Buenos_Aires | South America | sa |
| US/Pacific | North America / West | na-w |
| Europe/Paris | Europe | eu |

Embodiments are not limited to these examples, and other timezone-to-region mappings may be utilized. Further and in embodiments, Regions can also be represented as a bidirectional graph structure with the edges representing geographic neighbors. For example, na-e<->na-w and sa<->na-w and sa<->na-e. This representation is useful for node selection.

At 910, the client may identify or select a DNS record option returned at 904 that is in the region. If there are multiple matches, the client may select one at random. If there's no node available in a region, the client may determine and use a data graph of neighboring regions to select a node in the closest region where a node is available at 912. For example, sa has no node but is connected to na-e where there is a node and so na-e is selected. In some embodiments,

At 914, the client may resolve a selected node's hostname. In embodiments, the client 836 may automatically resolve the hostname using the client's HTTP request default resolver. At 916, the Domain Name System 802 may return a result. And at 918, the client 836 may communicate with a switchboard node 804 and begin the process to interact with the switchboard.

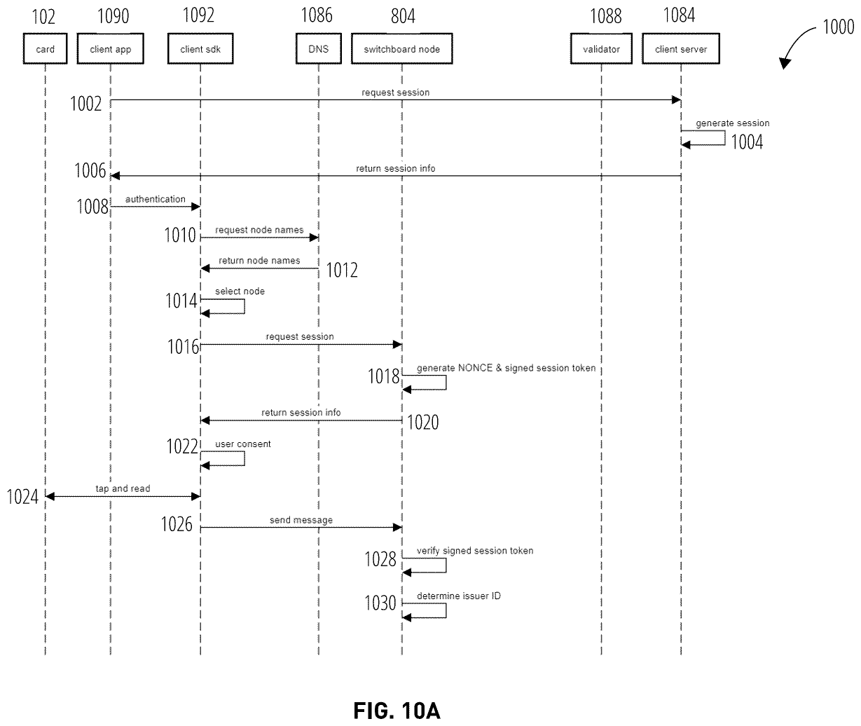

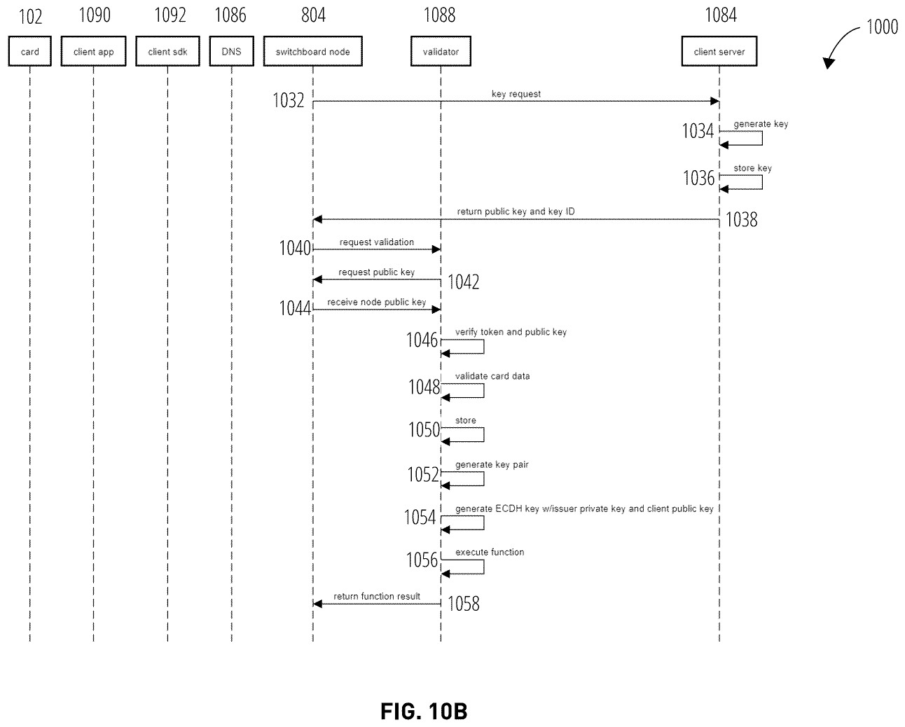

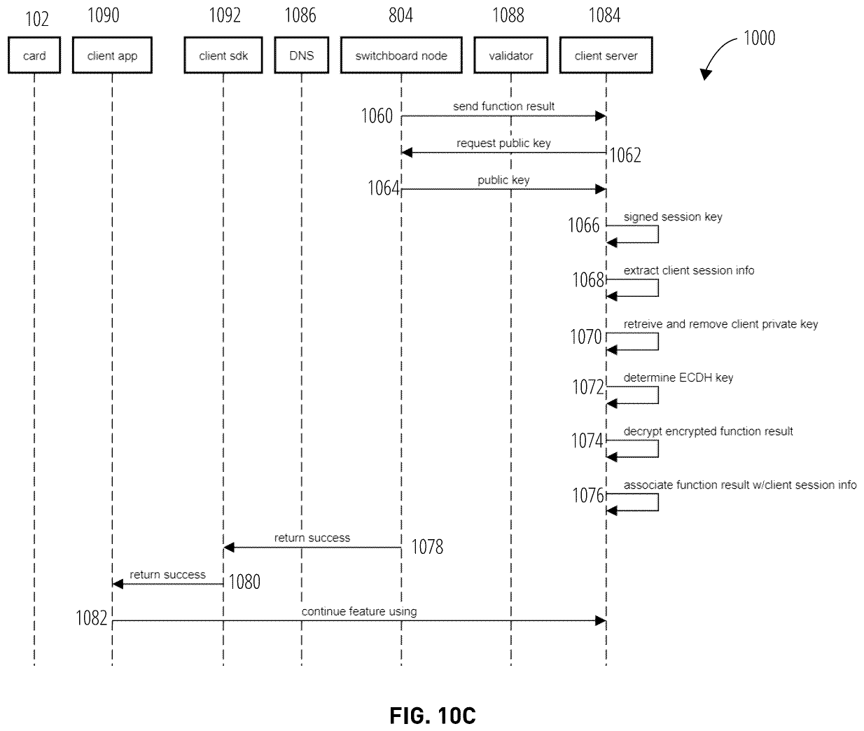

FIG. 10A-FIG. 10C illustrate an example sequence 1000 to perform operations between a card and services provided by a card issuer and/or merchant. The illustrated sequence 1000 includes actions and communications performed by a card such as payment card 102, a client 836 including a client app 1090 and a client sdk 1092, a DNS 1086, a switchboard system including one or more nodes 804, a partner services 832 including a merchant and/or validator 1088, and control services 834 including a client server 1084 or system. In embodiments, the client app 1090 may be any application configured to execute on a client 836, such as a banking app, a merchant app, a social media app, a travel app, a gaming app, a productivity app, an entertainment app, and so forth. In embodiments, the client app 1090 includes a web browser to provide websites and pages. The client app 1090 may include and/or utilize the client sdk 1092, which may be a set of instructions that enable the client app 1090 to communicate with other components of the switchboard system. In some embodiments, the terminal 104 and the client device 202 are examples of the client 836.

In embodiments, at 1002 the client 836 including the client app may send a request and establish a session with a client server 1084 such that a result may be associated with the correct client device or user. The request establishes a relationship between the client device and client server, which may be an issuer server. At 1004, the client server 1084 generates a session and CLIENT SESSION INFORMATION. At 1006, the client server 1084 returns the session information, e.g., the CLIENT SESSION INFORMATION. In embodiments, the CLIENT SESSION INFORMATION may be the Client implementation-specific user session identification information.

At 1008, the client 836 may initiate a contactless card authentication process with the client 836. For example, the client 836 may call a function and/or pass information to the client 836 to initiate authentication via a contactless card. At 1010-1014, the client 836 may utilize DNS to identify a node and establish communication with the node. Specifically, at 1010, the client 836 including the client sdk 1092 may send a request for switchboard hostnames, and at 1012 the DNS 1086 may return information including one or more hostnames. At 1014, the client 836 may determine a switchboard node to communicate. FIG. 9 illustrates an example of a more detailed sequence of the process to establish communication with a switchboard node.

At 1016, the client 836 may send a request for a session to the switchboard node 804. In embodiments, the request for a session may be for a function request in the format <FUNCTION REQUEST>. In embodiments, the FUNCTION REQUEST may be the data/function that the client would like to request once a contactless card has been validated. The function could be for any service discussed herein, e.g., authenticate the user, perform a transaction, request autofill data, etc. At 1018, switchboard node 804 may generate a nonce and a signed session token. The signed session token may be a JSON Web Token (JWT). When generating the JWT, the following elements should be set:
iss: The unique ID of the current node,
nonce: An 8 hex character, randomly generated nonce,
exp: The expiration timestamp (+5 minutes),
client_id: The requesting client's Client ID,
sub: The requesting client's Device Fingerprint,
sid: Arbitrary session info sent from the client,
scope: The function being requested to be performed.

The nonce may be unique, random bytes generated to ensure the unrepeatability of a message with a contactless card. The nonce is critical to the security and operation of the switchboard system. The nonce validity is tracked by tying it to a session which can be validated by any member of the platform. As mentioned, sessions are JSON Web Tokens signed using a node-specific private key issued by the network. These JWTs are verifiable by a system with the corresponding public key, which they can also verify by confirming it was issued by us or an approved delegate. The signed session token is a JWT-generated token to establish the validity and expiration of the nonce and to associate the contactless card tap to the current client session. For example, the signed session token includes <NONCE>, <CLIENT SESSION INFO>, and <FUNCTION REQUEST>signed with <NODE PRIVATE KEY>, where the NODE PRIVATE KEY is the switchboard system private key. The switchboard system may include a NODE PUBLIC/PRIVATE KEY, which is a keypair used to sign and validate JWTs.

At 1020, the switchboard node 804 may return session information to the client sdk 1092. The session information may include the signed session token (<SIGNED SESSION TOKEN>), the NONCE <NONCE>, the function terms of service <FUNCTION TOS>, and the terms of service version <TOS VERSION>. The FUNCTION TOS may be the terms of service that the user must consent to in order to allow the client to execute the requested function, and the TOS VERSION may be the version of the terms of service. At 1022, the client sdk 1092 may determine and/or receive user consent to the terms of service. In one example, the client sdk 1092 captures and records the user consent to <FUNCTION TOS> on <CONSENT DATE>with<TOS VERSION>. The CONSENT DATE may be the timestamp for the user's consent to the TOS.

At 1024, the client 836 exchanges one or more messages with a contactless card. In one example, the exchange may be based on the contactless card being tapped to a client device. In embodiments, the client sdk 1092 may provide data to the contactless card 102 to use during the session to perform the function. The data may be provided to the contactless card 102 in an NDEF message. In one example, the data is written to the card in NDEF format using a binary update command. The data may include a NONCE to provide a level of security that the message received from the card is part of the same session. Additionally, the data may include additional information, such as one or more control bits to control the format generated by the contactless card. Table 3 below illustrates an example of an NDEF message format.

| Byte | Data Item | Value |
|---|---|---|
| 00 | NDEF Message Tag | D1 (only record) |
| 01 | Length of Record | 01 |
| | Type | |
| 02 | Length of Record | 33 |
| 03 | text record type | 54 |
| 04 | Length of Language | 02 |
| 05-06 | Language | 65 6E (“en”) |
| 07 . . . 0E | NONCE | 8 bytes of ASCII HEX encoded 4 bytes binary data |
| 0F . . . 12 | Session Indicators | 4 bytes of ASCII HEX encoded 2 bytes binary data |
| 13 . . . 16 | Control Indicators | 4 bytes of ASCII HEX encoded 2 bytes binary data |
| 17 . . . 26 | Update Date | 16 bytes of ASCII HEX encoded 8 bytes binary data - |
| | creation Time | represents 64 bit unix timestamp |
| 27 . . . 36 | Update MAC | MAC to protect control indicators - 16 bytes of ASCII |
| | | HEX encoded 8 bytes binary data |

The updated MAC may be calculated to protect the control indicators in embodiments. Specifically, The MAC M is determined by calculating a MAC over the 10 bytes of the update data U with the Update MAC Card Key (MCK), as described herein.

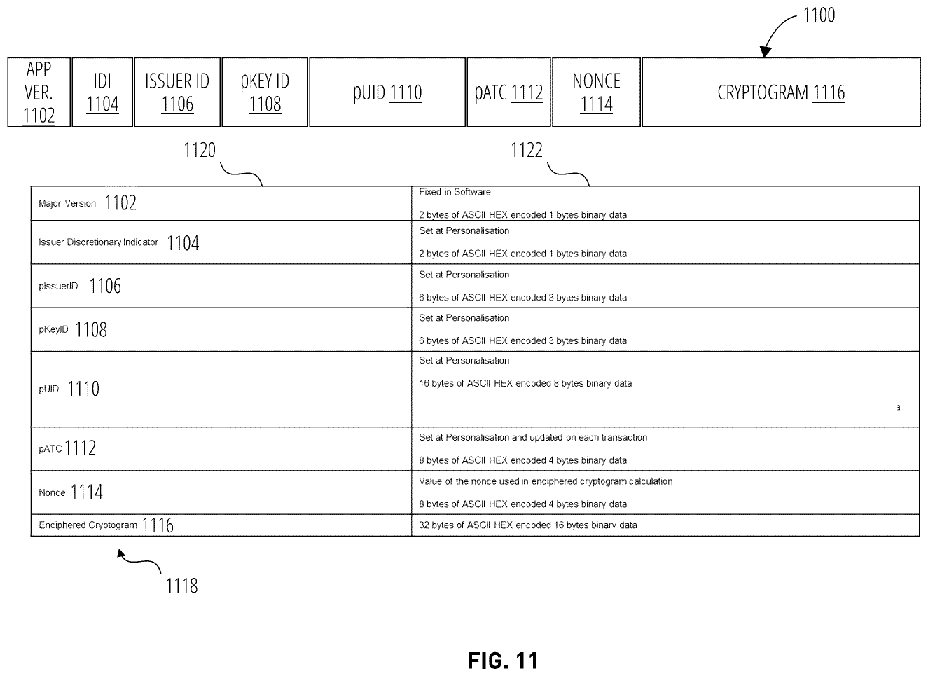

At 1024, the contactless card may generate and provide a message to the client's device including the client sdk 1092. The data in the message may be utilized by the system discussed herein to perform the function requested. One example of the message is illustrated and discussed in FIG. 11, message 1100.

At 1026, the client including the client sdk 1092 may send a message and information to the switchboard node 804. The message may be the message received from the contactless card 102, e.g., message 1100. In addition, the client sdk 1092 may send the consent date, the TOS version, and the signed session token to the switchboard node 804. The switchboard node 804 may utilize the information to ensure the session is valid. At 1028, the switchboard node 804 verifies the signed session token is valid, e.g., is the previously provided signed session token and includes the nonce previously generated and is in the message.

In some embodiments, the switchboard node 804 is configured to determine which issuer system or client-server it should route the message to for processing. At 1030, the switchboard node 804 may determine the issuer ID by extracting it from the message received from the contactless card 102 via the client sdk 1092. As mentioned, the issuer ID identifies the issuer of the contactless card 102.

In embodiments, the switchboard node 804 is configured to generate and communicate secure communications with the issuer system, e.g., the client server 1084 and the validator 1088. At 1032, the switchboard node 804 sends a request for a key to the client server 1084. The key may be utilized to perform secure communications. In one example, the key request may be an elliptical curve Diffie-Hellman (ECDH) key request. Embodiments are not limited in this manner. Alternative key protocols may be utilized, e.g., Supersingular isogeny Diffie-Hellman key exchange (SIDH or SIKE), a private/public key pairing (RSA), etc.

At 1034, the client server 1084 generates a portion of the key. In some instances, the client server 1084 may generate half of the ECDH key for encryption/decryption of PII. Specifically, the client server 1084 may generate <CLIENT EC PUBLIC KEY> and <CLIENT EC PRIVATE KEY>using Elliptic Curve P256. The CLIENT EC PUBLIC KEY AND CLIENT EC PRIVATE KEY is the first half of the ECDH key negotiation.

At 1036, the client server 1084 stores the generated portion of the key in storage. Specifically, the client server 1084 may store <CLIENT EC PUBLIC KEY> and <CLIENT EC PRIVATE KEY>with <KEY ID>, where the KEY ID is used by the Client Server to cache its short-lived EC public/private key for later ECDH key completion, e.g., to identify the ECDH key portions to generate the whole ECDH key. In one example, the key may be stored in a secure memory location and may be used to when PII is received for the session.

In embodiments, the client server 1084 may return the public key portion to the switchboard node 804 with the KEY ID at 1038. The switchboard node 804 may store the public key portion with the KEY ID for later use, e.g., generation of the ECDH key. At 1040, the switchboard node 804 may request a validation to be performed by the validator 1088. In one example, the switchboard node 804 may send a request validation as Request validation <MESSAGE>, <SIGNED SESSION TOKEN>, <CLIENT EC PUBLIC KEY>, <CONSENT DATE>, and the <TOS VERSION>. The validator 1088 may make an out-of-band request back to the switchboard system node 804 for the public key to verify the session at 1042. At 1044, the switchboard system node 804 may provide the node's public key, i.e., <NODE PUBLIC KEY>. Further at 1046, the validator 1088 may utilize the node's public key to verify the secure session token.

In embodiments, the validator 1088 may validate the message at 1048. In embodiments, the validator 1088 may perform a number of validations including ensuring the nonce in the message is correct along with additional information, such as the card's unique identifier (pUID), and the counter value (pATC). Additional details of a validation process that may be performed are described elsewhere herein.

At 1050, the validator 1088 may store information associated with the session. For example, validator 1088 may store the <CONSENT DATE>with the <TOS VERSION> and the <PUID>. The validator 1088 may also generate another portion of the key, e.g., the ECDH key. For example, the 1088 may Generate <ISSUER EC PUBLIC KEY> and <ISSUER EC PRIVATE KEY>using Elliptic Curve P256. The ISSUER EC PUBLIC KEY and ISSUER EC PRIVATE KEY may be the second half of the ECDH key negotiation.

At 1054, the validator 1088 may generate the complete ECDH key. For example, the validator 1088 generates the <ECDH KEY> from <ISSUER EC PRIVATE KEY> and <CLIENT EC PUBLIC KEY>. The ECDH KEY is the final key generated using ECDH key negotiation.

The validator 1088 may utilize the ECDH KEY to encrypt data for the function. For example, if the validator 1088 validates the message in some instances, the validator 1088 may execute a function request to create a function result and encrypt the result with the ECDH KEY at 1056. For example, the validator 488 may Execute <FUNCTION REQUEST> to create <FUNCTION RESULT> and encrypt it with the <ECDH KEY>. The function result may be any result based on the requested function, e.g., verification of the card.

At 1058, the validator 1088 may return the function result to the switchboard node 804. In some instances, the function result is returned encrypted. For example, the validator 1088 may return the <ENCRYPTED FUNCTION RESULT> and the <ISSUER EC PUBLIC KEY>.

In embodiments, the switchboard node 804 sends the function result to the client server 1084 to process the result. In one example, the switchboard node 804 may send the <ENCRYPTED FUNCTION RESULT>, <KEY ID>, <ISSUER EC PUBLIC KEY>, and <SIGNED SESSION TOKEN>. At 1062 and 1064, the client server 1084 may make a request for and receive the public key from the switchboard node 804. In some instances, the exchange may be performed via out-of-band communication channels. The public key for the node may be <NODE PUBLIC KEY>. The public key may be used to verify the sender of the function result, etc. At 1066, the 1084 may verify the signed session key with the node's public key <NODE PUBLIC KEY> to verify the sender of the information. At 1068, the client server 1084 may extract client information from the signed session token. For example, the client server 1084 may Extract <CLIENT SESSION INFO> from <SIGNED SESSION TOKEN>, i.e., extracting the client implementation-specific user session identification information.

Further, at 1070, the client server 1084 may retrieve the client's private key with the KEY ID. Specifically, the client server 1084 may get and remove the <CLIENT PRIVATE KEY> from cache using the <KEY ID>. At 1072, the client server 1084 may generate or compute the ECDH key. For example, the client server 1084 may compute the <ECDH KEY>with the <CLIENT PRIVATE KEY>+<ISSUER EC PUBLIC KEY>. The client server 1084 may decrypt the function result with the computed key at 1074. Specifically, the client server 1084 may decrypt the <ENCRYPTED FUNCTION RESULT>with the <ECDH KEY> to determine the <FUNCTION RESULT>. At 1076, the client server 1084 associates the function result with the session.

In embodiments, the switchboard node 804 may return whether the function result was successfully completed or not at 1078 to the client sdk 1092. Further at 1080, the client sdk 1092 may notify the client app 1090 of the result. At 1082, the client app 1090 may utilize the feature. For example, the 1082 may communicate with the client server 1084 to continue the feature using the <CLIENT SESSION INFO> to fetch the redacted <FUNCTION RESULT>.

In some embodiments, the operations performed by the payment card 102 (and other entities by association) in any FIG. 10A, FIG. 10B, and FIG. 10C may be conditioned on successful power-based handshake verification described herein. For example, the payment card 102 may provide an indication of one or more predetermined threshold values 112 to the client 836. The client 836 may accept the request and cause the power source 122 to provide voltage, wattage, resistance, and/or amperage corresponding to the predetermined threshold values 112. In some embodiments, the client 836 causes the power source 122 to provide power corresponding to a time duration specified in one of the predetermined threshold values 112. The measurement circuitry 110 may then determine the voltage, current, resistance, time duration, and/or wattage of a signal provided by the client 836. If the determined voltage, current, resistance, time duration, and/or wattage is not equal to the corresponding one or more predetermined threshold values 112 (or is not within a range of the predetermined threshold values 112), the payment card 102 may refrain from performing the operations described in any of FIG. 10A, FIG. 10B, and FIG. 10C.If, however, the determined voltage, current, resistance, time duration, and/or wattage is equal to the corresponding predetermined threshold value 112 (or is within a range of predetermined threshold values 112), the payment card 102 may perform the operations associated with the card described in any of FIG. 10A, FIG. 10B, and FIG. 10C. Embodiments are not limited in these contexts.

FIG. 11 illustrates an example of a message 1100 that may be communicated by a contactless card to perform the functions described herein, such as those discussed in FIG. 10A through FIG. 10C. One or more of the fields in message 1100 may also be utilized to route the message 1100 through the switchboard system and perform authentication/validation techniques.

In embodiments, the message 1100 includes an applet version 1102 field, an issuer discretionary indicator 1104 field, an Issuer Identifier 1106 field, a pKey ID 1108 field, a pUID 1110 field, a pATC 1112 field, a nonce 1114 field, and an encrypted cryptogram 1116.

In embodiments, the fields may be in plain text or encrypted. For example, the applet version 1102 field may include an applet version in plain text. The applet version indicates which applet version is installed on a contactless card and may be used by the other systems to determine how to process the message 1100 when communicated. For example, different Applet versions require different validation logic, e.g., an older message may be routed through the issuer system to perform various operations for validation, while a newer message may be routed through the switchboard system to perform the various operations, including validation.

In embodiments, the message 1100 includes an issuer discretionary indicator 1104 field that may include issuer data and set at the time of personalization. In addition, the message 1100 includes an Issuer Identifier 1106 field that may include a unique ID assigned to the entity issuing the card, e.g., the issuer. For example, when joining the system, each issuer may be assigned a unique identifier during an onboarding operation. The issuer ID can be used by the switchboard system 800 to route a message and its contents to the appropriate services that are associated with that particular issuer.

In embodiments, the message 1100 includes a pKey ID 1108 field. In some instances, the pKey ID 1108 field may include data that identifies a set of master keys for a card issuer. The issuer's set of master keys may utilize each card's set of derived master keys or unique derived keys (UDK). Further, each card's own set of master keys (UDKs) may be generated during the personalization of the card. The card's UDKs may be utilized to generate session keys that are used to generate the application cryptogram. The session keys generated by a card may be regenerated by a system, e.g., the validator system, utilizing pKeyID to identify the issuer's master keys to regenerate session keys by the system to perform a validation.

In embodiments, each payment card 102 is given a unique 16-decimal digit identity (pUID) at the time of personalization. Derivation of the card applet's unique keys using the pUID is performed off-card. The resultant Application Keys are injected during the personalization of the card. In embodiments, a card's Application Keys are the same as the card's derived master keys or UDKs. The process for deriving the Application Keys (UDKs) is described herein.

The message 1100 may include a pUID 1110 field, including a card unique identifier assigned to the contactless card at personalization time. The pUID 1110 field data may be a combination of alphanumeric characters used to identify each card and associated with a user uniquely.

In embodiments, the message 1100 includes a pATC 1112 field configured to hold a counter value. The counter value keeps a count of reads (taps) made on the contactless card in a hexadecimal format in one example. Further, a counter value may be used to generate session keys to encrypt at least a portion of a message.

In embodiments, each time a message 1100 is created, a new session key is derived and utilized to generate one or more portions of the message 1100. Specifically, a session key is used to calculate the cryptographic MAC (Application Cryptogram). The card's applet supports a session key derivation option to generate a unique cryptogram session key ASK, and a unique encipherment session key (DESK).

In embodiments, a portion of the data provided in message 1100 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In embodiments, the payment card 102 may communicate a message between a device, such as a mobile device, during a read operation. For example, in response to the payment card 102 being tapped onto a surface of the device, e.g., brought within wireless communication range, a read operation may be performed on the payment card 102, and the payment card 102 may generate and provide the message to the device. For example, once within range, the payment card 102 and the device may perform one or more exchanges for the payment card 102 to send the message to the device.

The wireless communication may be in accordance with a wireless protocol, such as near-field communication (NFC), Bluetooth, WiFi, and the like. In some instances, a message may be communicated between a payment card 102 and a device via wired means, e.g., via the contact pad, and in accordance with the EMV protocol.

As discussed above, the contactless card may be deployed with a unique card key, e.g., the UDK, that is generated from an issuer's master key and is used to generate session keys. The following discusses the generation of the UDK and the session keys (ASK) and (DESK). Further, the contactless card may generate encrypted data or a cryptogram comprising data as discussed herein with the generated keys. The encrypted data may be encrypted with session keys that are changed each time data is encrypted. In one embodiment, the session keys are generated from card master keys or unique diversified keys that are stored on the contactless card. The unique diversified keys may be generated from the issuer's master keys. For example, in some instances, operations to generate the unique diversified keys may be performed off the card at personalization time and then stored in the memory of the card. Further, the issuer's master key(s) may be utilized to generate card master keys. The card master keys may also be known as application keys or UDKs. Each contactless card may have one or more UDKs.

In embodiments, each contactless card includes one or more applications, such as an authentication application, that is given a unique 16-digit identity (pUID) at time of personalization. Each contactless card may also receive application keys, which may also be known as unique card keys (UDKs) or card master keys using the pUID. In some instances, these operations are performed off-card, and the resultant keys are injected during personalization. However, in other instances, one or more of the operations may be performed on the card, e.g., at the time of manufacture, each time an operation is performed with a key, and so forth.

Embodiments include a system configured to generate a number of issuer master key sets and assign each a unique three-byte pKey identifier (pKey ID). As mentioned, systems discussed herein may support many card issuers, and each card issuer may have one or more of its own sets of unique issuer master keys that can be identified with a pKey ID. For each application, such as the authentication application, the system may perform the following operations to generate application keys or UDKs.

In embodiments, the system assigns a pKey ID to a card or pUID, a card application's unique 16-decimal digital identity. The system initiates generating a card's UDK(s). Specifically, the system generates a 16-digit quantity (X) from the 16-digit pUID. In one example, the 16-digit X may be generated by randomly rearranging the 16-digit pUID. In another example, X may be the same as the 16-digit pUID. Embodiments are not limited in this manner, and other techniques may be utilized to generate X from the 16-digit pUID. In embodiments, the 16-digit quantity X may be utilized to generate one or more UDKs.

In instances, the system computes or calculates a first portion (ZL) by encrypting X with an issuer master key. An encryption algorithm, such as DES or DES variant, may be utilized in embodiments. Embodiments are not limited in this manner, and other examples of encryption algorithms include AES and public-key algorithms, such as (RSA).

The system calculates or computes a second portion ZR by XOR'ing X with FFFFFFFFFFFFFFFF and encrypting the result with an issuer master key. Again, an encryption algorithm such as DES, AES, RSA, etc., may be used to encrypt the result of the XOR'ing. The system generates an application key or UDK. Specifically, the system concatenates ZL with ZR to form the application key. Embodiments are not limited to concatenating the two portions (ZL and ZR). They may be combined using other techniques. Additionally, the above-described process can be performed any number of times to generate additional application keys, e.g., by utilizing different master issuer keys. In embodiments, a contactless card stores the generated application key(s) or UDK(s).

In embodiments, the contactless card utilizes the application key(s) or UDK(s) to generate session keys for each encrypted data is generated. The following is one processing flow that may be performed by the contactless to generate a unique cryptogram session key (ASK).

To generate the ASK, the contactless card computes SKL by encrypting [ATC[2]∥ATC[3]∥‘F0’∥‘00’∥[ATC[0]∥[ATC[1]∥[ATC[2]∥[ATC[3]] with an application key. Further, the contactless card computes SKR by encrypting [ATC[2]∥ATC[3]∥‘OF’∥‘00’∥[ATC [0]∥[ATC[1]∥[ATC[2]∥ [ATC[3]] with the application key. Finally, the contactless card concatenates SKL with SKR to form an authentication session key (ASK). In embodiments, the ASK is used to perform operations utilizing the contactless card, such as encrypting the cryptographic MAC.

In embodiments, the contactless card also supports session key derivation to generate a unique encipherment session key DESK. The contactless card computes an SKL by encrypting [ATC[2]∥ATC[3]∥‘F0’∥‘00’∥‘00’∥‘00’∥ ‘00’∥‘00’] with a Data Encryption Key (DEK) or UDK. Further, the contactless card computes SKR by encrypting [ATC[2]∥ATC[3]∥‘0F’∥‘00’∥‘00∥‘00’∥‘00’∥‘00’] with the DEK or UDK. The contactless card concatenates SKL with SKR to form the Data Encipherment Session Key (DESK).

In embodiments, the contactless card generates encrypted data or a cryptogram utilizing the session keys. Specifically, the contactless card generates a cryptogram C by calculating a MAC over the 32-byte transaction data T using the Authentication Session Key (ASK).

The contactless card may process the data to generate the cryptogram. Specifically, the contactless card divides T into four blocks of 8 bytes of data: T=T1∥T2∥T3∥T4. The contactless card computes B=DES(ASKL) [T1], where is the Data Encryption Standard or another symmetric encryption algorithm, ASKL is a portion of the ASK, e.g., the “left” half of the key. The contactless card computes B=[B XOR T2], and, the contactless card computes B=DES(ASKL) [B], where DES is an encryption algorithm. The contactless card computes B=[B XOR T3], and the contactless card computes B=DES(ASKL) [B]. The contactless card computes B=[B XOR T4], and the contactless card computes B=DES(ASKL) [B]. The contactless card computes B=DES⁻¹(ASKR) [B], where DES⁻¹ is the reciprocal DES operation, and ASKR is a portion of the ASK, e.g., the right half. The contactless card computes the cryptogram C=DES(ASKL) [B].

In embodiments, a contactless card may also encipher the cryptogram to secure the data further. For example, a contactless card may generate an 8-byte random number [RND] and the card computes E1=DES3(DESK) [RND], where DES3 is a symmetric encryption algorithm such as the Triple Data Encryption Standard. The contactless card then computes B=[E1]XOR [C], where C is the cryptogram generated, as discussed above. The contactless card computes E2=DES3(DESK) [B], where B is computed above. Further, the contactless card generates the 16-byte enciphered payload E=[E1]∥[E2].

In embodiments, a device or the contactless card may decrypt the payload E by determining, receiving, or retrieving the payload E. The device computes a RND=DES3⁻¹(DESK) [E1]. The device determines B=DES3⁻¹(DESK) [E2], and the device computes C=[E1] XOR [B].

In embodiments, the payment card 102 generates or calculates a message authentication code (MAC). In some instances, the MAC may be an updated MAC. In embodiments, the updated MAC is included in data communicated from a contactless card to another device, such as a mobile device, point-of-sale (POS) terminal, or any other type of computer. In one example, the updated MAC may be included in an NDEF message.

In embodiments, the updated MAC may be calculated to protect the control indicators and include an updated date/time. For example, the update MAC M is determined by calculating a MAC over the 10 bytes of the updated data U with the Updated MAC Card Key (MCK) as follows.

Embodiments include determining data to process through a number of calculations and computations. In one example, the data U equals the [Control Indicators (2 bytes)∥Update Date Time (8 bytes)∥‘80’∥‘00 00 00 00 00’]. For the calculations, the data may be divided into two separate portions. Specifically, the data U is broken into two blocks of 8 bytes of data, where U=U₁∥U₂. Further, operations may be performed on U₁ and U₂.

Embodiments include applying an algorithm to the first portion (U₁) of the data. In one example, a result B may be computed where B=DES(MCKL) [U1], where DES is a Data Encryption Standard algorithm using a first portion (L) of the MAC Card Key (MCKL).

Further, an additional operation may be performed on the result B. Specifically, the result B may be exclusively or′d (XOR) with a second portion of the data (U₂).

The updated result B may be further processed. For example, result B may be further processed by applying the DES algorithm using MCKL again to B. The result the inverse DES may process B with a second portion (R) of the MCK (MCKR), and the MAC M may be determined by applying the DES algorithm with the MCKL to result B.

In some embodiments, generation of message 1100 according to the techniques described in FIG. 11 (or elsewhere herein) may be conditioned on successful power-based handshake verification described herein. For example, the payment card 102 may provide an indication of one or more predetermined threshold values 112 to the terminal 104 (and/or client 836). The terminal 104 may accept the request and cause the power source 122 to provide voltage, wattage, resistance, and/or amperage corresponding to the predetermined threshold values 112. The measurement circuitry 110 may then determine the voltage, current, resistance, and/or wattage of a signal provided by the terminal 104. If the determined voltage, current, resistance, and/or wattage is not equal to the corresponding one or more predetermined threshold values 112 (or is not within a range of the predetermined threshold values 112), the payment card 102 may refrain from generating a message 1100 to preserve security. If, however, the determined voltage, current, resistance, and/or wattage is equal to the corresponding predetermined threshold value 112 (or is within a range of predetermined threshold values 112), the payment card 102 may generate the message 1100 according to FIG. 11 In some embodiments, the message 1100 includes an indication of the predetermined threshold value 112 of the payment card 102. Embodiments are not limited in these contexts.

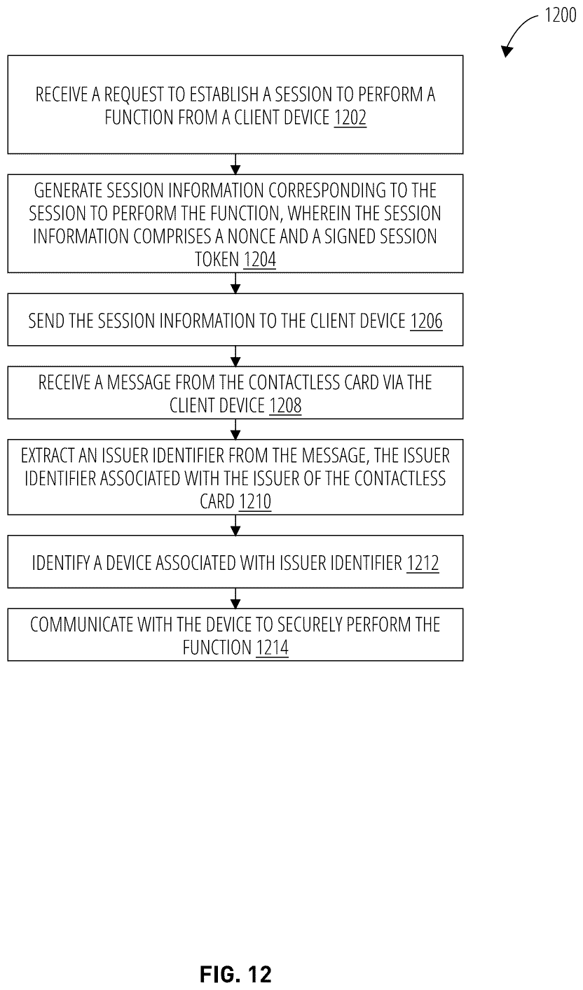

FIG. 12 illustrates an example of routine 1200 in accordance with embodiments discussed herein. In block 1202, the routine 1200 includes receiving, by a node in a system, a request to establish a session to perform a function from a client device, wherein the function is at least partially performed utilizing a contactless card such as payment card 102. In some embodiments, the terminal 104, client device 202, and/or the client 836 is the client device. In some instances, the node may be one of a plurality nodes of a switchboard system. The node may be previously selected by the sending device via a DNS operation performed.

In block 1204, the routine 1200 includes generating, by the node, session information corresponding to the session to perform the function, wherein the session information comprises a nonce and a signed session token. The nonce and/or signed session token may be utilized by systems to perform the functions described herein while ensuring the node routing the data is authenticated, the message from the contactless card is authenticated, and to keep track of the session for the function.

In block 1206, routine 1200 includes sending the session information to the client device by the node. The client device may communicate with a contactless card such as payment card 102 to receive data from the card to authenticate and perform a function. In some instances, the client device may send the nonce from the node to the contactless card. The contactless card may utilize the nonce when generating the message to communicate back to the client device. Finally, the node, e.g., incorporates it into a cryptographic portion of the message (see FIG. 11). As stated, the payment card 102 may condition the generation of the message 1100 at block 1206 based on successful power-based handshake verification described herein.

In block 1208, routine 1200 includes receiving, by the node, a message from the contactless card via the client device. The message may be generated by the contactless card. FIG. 11 illustrates one example of a message 1100. In some embodiments, the node verifies the message. For example, the node may verify a nonce in the message and a signed session token.

In block 1210, routine 1200 extracts an issuer identifier from the message by the node, the issuer identifier associated with the issuer of the contactless card. In some instances, the issuer identifier may be in a plaintext format.

In block 1212, routine 1200 identifies, by the node, a device associated with the issuer identifier. For example, the node may perform a lookup to determine a server associated with the issuer identifier and the function to be performed.

In block 1214, routine 1200 communicates, by the node, with the device to securely perform the function.

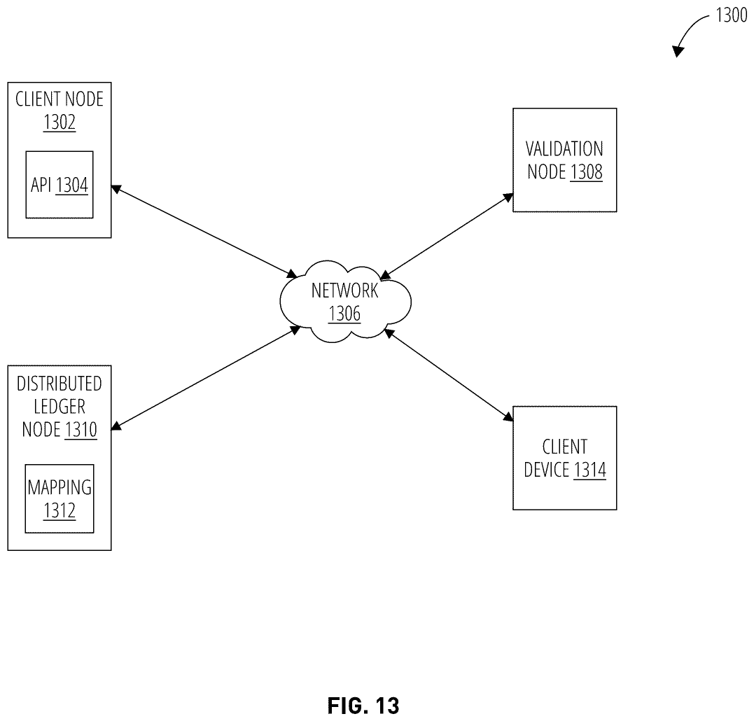

FIG. 13 illustrates a distributed network authentication system 1300 according to an example embodiment. As further discussed below, system 1300 can include client node 1302, API 1304, network 1306, distributed ledger node 1310, mapping 1312, and client device 1314. Although FIG. 13 illustrates single instances of the components, system 1300 can include any number of components. The terminal 104, client device 202, and client 836 are examples of client device 1314 and/or client node 1302.

System 1300 can include a client node 1302, which can be a network-enabled computer as described herein. In some examples, client node 1302 can be a server, which can be a dedicated server computer, a blade server, or can be a personal computer, a laptop computer, a notebook computer, a palm top computer, a network computer, a mobile device, a wearable device, or any processor-controlled device capable of supporting the system 1300.

In some examples, client node 1302 can execute one or more applications, such as software applications, that enable, for example, network communications with one or more components of system 1300, transmit and/or receive data, and perform the functions and processes described herein.

The client node can contain an API 1304. For example, various different APIs can be provided for an application (e.g., executed on a computing device, such as a network-enabled computer) that can interact with a service. For example, an application executed on a device (e.g., a smart phone, smart watch, tablet, laptop, or other device) call interact with a web-based service by calling the API 1304 to interact with the service, such as by performing a remote call to an API for interacting with a web-based service.

API 1304 can be provided in the form of a library that includes specifications for routines, data structures, object classes, and variables. In some cases, such as for representational state transfer (REST) services, an API (e.g., a REST API or RESTful API, or an API that embodies some RESTful practices) is a specification of remote calls exposed to the API consumers (e.g., applications executed on a client computing device can be consumers of a REST API by performing remote calls to the REST API). REST services generally refer to a software architecture for coordinating components, connectors, and/or other elements, within a distributed system (e.g., a distributed hypermedia system).

Client node 1302 can communicate with one or more other components of system 1300 either directly or via network 1306. Network 1306 can comprise one or more of a wireless network, a wired network or any combination of wireless network and wired network, and may be configured to connect the components of system 1300. While FIG. 13 illustrates communication between the components of system 1300 through network 1306, it is understood that any component of system 1300 can communicate directly with another component of system 1300, e.g., without involving network 1306.

System 1300 can include a validation node 1308, which can be a network-enabled computer as described herein. In some examples, validation node 1308 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, validation node 1308 can execute one or more applications, such as software applications, that enable, for example, network communications with one or more components of system 1300, transmit and/or receive data, and perform the functions and processes described herein.

In some examples, each validation node can be associated with a routing number, and the routing number identifies the entity controlling the keys for the authentication namespace. The authentication namespace can be related to one or more of a particular entity, a particular set of cards, or a particular set of security keys (e.g., master keys, diversified keys, session keys) associated with an entity, a set of cards, or a type of cards.

System 1300 can include a distributed ledger node 1310, which can be a network-enabled computer as described herein. In some examples, distributed ledger node 1310 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300.

In some examples, distributed ledger node 1310 can execute one or more applications, such as software applications, that enable, for example, network communications with one or more components of system 1300, transmit and/or receive data, and perform the functions and processes described herein.

Distributed ledger node 1310 can contain a mapping 1312. In some examples, mapping 1312 can be in the form of one or more databases. Exemplary databases can include, without limitation, relational databases, non-relational databases, hierarchical databases, object-oriented databases, network databases, and any combination thereof. The one or more databases can be centralized or distributed. The one or more databases can be hosted internally by any component of system 1300, or the one or more databases can be hosted externally to any component of the system 1300. In some examples, the one or more databases can be contained in the distributed ledger node 1310, and in other examples the one or more databases can be stored outside of distributed edger node 1310 but in data communication with distributed ledger node 1310. The one or more databases can be implemented in a database programming language. Exemplary database programming languages include, without limitation, Structured Query Language (SQL), MySQL, HyperText Markup Language, JavaScript, Hypertext Preprocessor Language, Practical Extraction and Report Language, Extensible Markup Language, and Common Gateway Interface. Queries made to the one or more databases can be implemented in the same database programming language used to implement the one or more databases. For example, if the one or more databases are an SQL database, then queries made to the database can be made in SQL (e.g., SELECT column1, column2 FROM table1, table2 WHERE column2=‘value’;). It is understood that the one or more databases can be implemented in any database programming language and that the programming implementation of the query can be adjusted as necessary for compatibility with the one or more databases and to reflect the particular information to be queried.

In some examples, the one or more databases can be contained within distributed ledger node 1310. In other examples, the one or more databases can be remote from distributed ledger node 1310 but in data communication with distributed ledger node 1310. Data communication between the one or more databases and distributed ledger node 1310 can be a direct data communication or data communication via a network, such as the network 1306.

In some examples, client node 1302 can be in data communication with distributed ledger node 1310. Distributed ledger node 1310 can contain mapping 1312. Mapping 1312 may include, e.g., a mapping between a validation node address and the validation node 1308, a mapping between a routing number and a validation node address, and/or a mapping between a routing number and validation node 1308. In some examples, mapping 1312 can include a digital signature associated with an entity having permission to validate for a routing number. Based on one or more of these associations, client node 1302 can call validation node for validation and/or provide direction to the client device to reach the appropriate validation node. This can be accomplished by calling a validation API associated with validation node 1308.

In some examples, iterations of the mappings described herein, such as mapping 1312, can also include a software or applet version number. The version number can be used to identify a validation node or validation node address or choose between multiple validation addresses for one validation node.

In some examples, client node 1302 and distributed ledger node 1310 can be permissioned (e.g., allowed to join a network) with the aid of a certificate and/or a cryptographic authentication mechanism (e.g., a non-fungible token). The certificate and/or a cryptographic authentication mechanism may be issued by, e.g., a consortium authority or other administrative entity associated with the distributed network. If granted appropriate permissions, distributed ledger node 1310 can update mapping 1312 to reflect a different association between, e.g., a routing number, a validation node address, and a validation node. In some examples, degrees of permissions can be issued. For example, if client node 1302 were to function to route data to validation node 1308 (or other validation nodes), client node 1302 can be given a certain level of permissions. As another example, if distributed ledger node 1310 were to have the capability to update mapping 1312, distributed ledger node 1310 can have a different, higher level of permissions.

System 1300 can include a client device 1314, which can be a network-enabled computer as described herein. In some examples, client device 1314 can be a server, which can be a dedicated server computer, a bladed server, or can be a personal computer, a laptop computer, a notebook computer, a palm top computer, a network computer, a mobile device, a wearable device, or any processor-controlled device capable of supporting the system 1300. Client device 1314 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In some examples, client device 1314 can be in data communication with another network-enabled computer not shown in FIG. 13, such as a smart card (e.g., the payment card 102, a contactless card, a contact-based card, etc.).

In some examples, client device 1314 can execute one or more applications, such as software applications, that enable, for example, network communications with one or more components of system 1300, transmit and/or receive data, and perform the functions and processes described herein.

In some examples, upon receipt of an authentication request, client device 1314 can call (e.g., via an API) client node 1302. The call can include a routing number and/or an applet or software version number, and client node 1302 can query distributed ledger node 1310 and mapping 1312. Once the query returns the identification of a validation node (e.g., validation node 1308) and/or a validation node address associated with that routing number and/or applet or software version, client node 1302 can reply to client device 1314. Client device 1314 can then proceed with authentication with the validation node. The authentication can be performed by, e.g., the systems and methods described herein, such as by the generation, encryption, transmission, decryption, and validation of a cryptogram as described herein.

In some examples, client node 1302 can be co-resident with validation node 1308. In these examples, client node 1302 can handle the authentication in a single call from client device 1314. In some examples, this can be acceptable only if it is permissible for the full authentication transmission (e.g., a cryptogram as described herein) to be sent to client nodes that are not involved in authentication.

In some examples, if client node 1302 receives, from client device 1314, a routing number that is not handled by its location, client node 1302 can return a code indicating that this routing number is not handled, along with validation node address for the responsible validation node. Client device 1314 can then send the full authentication transmission to validation node 1308 using the received validation node address.

In some examples, client node 1302 can enter the distributed network with different permissions. For example, client node 1302 can be a read-only router of data. As another example, client node 1302 can have permission to send messages to distributed ledger node 1310 updating one or more routing paths for one or more routing numbers. However, client node 1302 would be prevented from updating one or more routing paths for one or more routing numbers for other entities that control other routing numbers which are not associated with client node 1302 or that did not grant this permission. As another example, distributed ledger node 1310 can contain contracts and/or records that can validate the permission of a specific entity to change a specific routing record based on its digital signature. As another example, the consortium authority or other administrative entity controlling the distributed network can have additional privileges to, without limitation, add new members (e.g., client nodes, distributed ledger nodes, validation nodes, and/or client devices), add new signature credentials, add new keys, add new certifications, and also to revoke any of the foregoing. In some examples, the foregoing permissions can be delegated to client node 1302, distributed ledger node 1310, and/or validation node 1308, if security, legal, and/or financial conditions are met, however, delegation is not required.

In some examples, one or more APIs can facilitate communication between components of system 1300 via network 1306. In other examples, one or more APIs are not required. Rather, the components of system 1300 could be in direct communication and/or dedicated to one or more specified entities, to allow the specified entities to keep data from being transferred to, transferred from, or transferred via, non-specified entities. This may further promote data security and avoid detection of data traffic patterns by non-specified entities.

In some examples, entities could establish a standard for nodes having APIs based on the intended function of those nodes. For example, a first standard could be established for data routing nodes and a second standard could be established for nodes performing mapping and/or authentication functions. As another example, a routing API, a mapping API, and a validation API can be established, which can allow for the same device or hardware configuration to perform these functions. However, the use of keys, including secret keys by validation node 1308 for authentication, can require storage of the keys in one or more HSMs, to promote key security and ensure that the keys are never entered into memory.

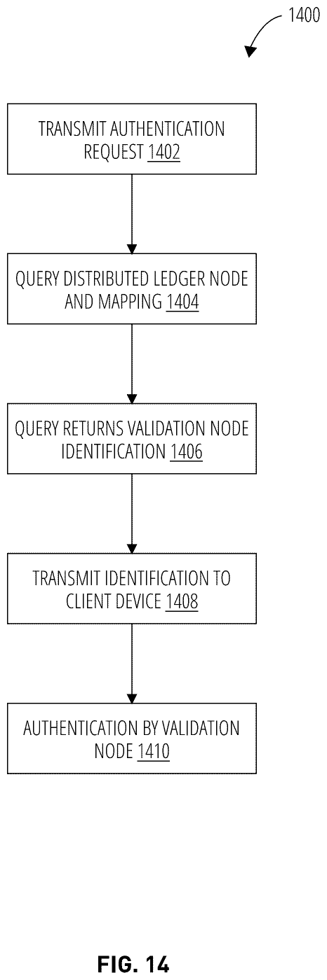

FIG. 14 illustrates a method 1400 performed by a distributed network authentication system according to an example embodiment. For example, the method can be performed by distributed network authentication system 1300 and or by another distributed network authentication system.

In block 1402, a client device can transmit an authentication request to a client node. The authentication request can include, without limitation, a routing number, a software version number, and/or an applet version number. The request can be made by an API call or other communication between the client device and the client node.

In block 1404, after receiving the authentication request, the client node can transmit a query (e.g., via an API call) to a distributed ledger node. The distributed ledger node contain a mapping, and the distributed ledger node can submit the query to the mapping.

In block 1406, the query can return an identification of a validation node and/or a validation node address, and the distributed ledger node can transmit this identification to the client node.

In block 1408, the client node can transmit the identification to the client device. After receiving the identification, the client device can proceed with authentication with the identified validation node and/or validation node address, in block 1410.

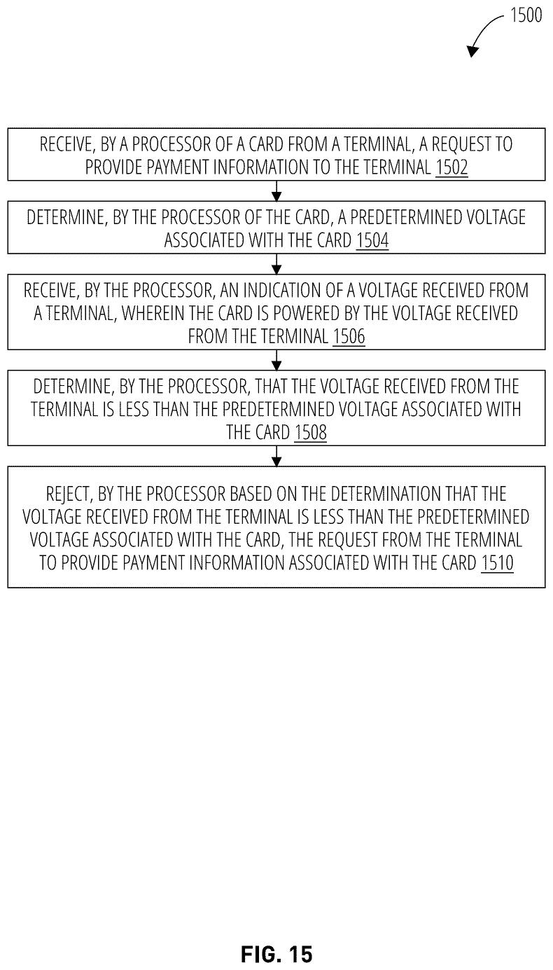

FIG. 15 illustrates a logic flow 1500. The logic flow 1500 may be representative of some or all of the operations executed by one or more embodiments described herein. For example, the logic flow 1500 may include some or all of the operations to perform voltage-based handshake verification. Embodiments are not limited in this context.

In block 1502, logic flow 1500 may receive, by a processor 502 of a card such as payment card 102 from a terminal such as terminal 104, a request to provide payment information to the terminal. In block 1504, logic flow 1500 may determine, by the processor 502 of the payment card 102, a predetermined threshold such as predetermined threshold value 112 associated with the payment card 102. The processor 502 may provide the predetermined threshold value 112 to the terminal 104. In block 1506, logic flow 1500 may receive, by the processor 502, an indication of a voltage of an electric signal received from the terminal 104, wherein payment card 102 is powered by the voltage of the electric signal received from the terminal 104. In block 1508, logic flow 1500 may determine, by the processor 502, that the voltage received from the terminal 104 is less than the predetermined threshold value 112 associated with the payment card 102. In block 1510, logic flow 1500 may reject, by the processor 502 based on the determination that the voltage received from the terminal is less than the predetermined threshold value 112 associated with the card, the request from the terminal to provide payment information associated with the contactless card to improve security.

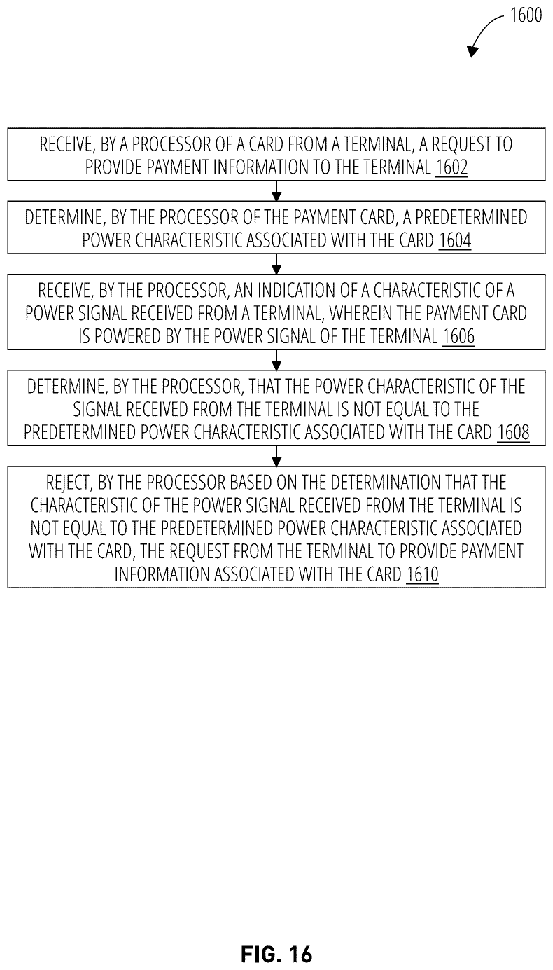

FIG. 16 illustrates a logic flow 1600. The logic flow 1600 may be representative of some or all of the operations executed by one or more embodiments described herein. For example, the logic flow 1600 may include some or all of the operations to perform power-based handshake verification. Embodiments are not limited in this context.

In block 1602, logic flow 1600 may receive, by a processor 502 of a card such as payment card 102 from a terminal such as terminal 104, a request to provide payment information to the terminal. In block 1604, logic flow 1600 may determine, by the processor 502 of the payment card 102, a predetermined power characteristic associated with the payment card 102. The predetermined power characteristic may be one or more of a voltage value, an amperage value, a resistance value, or a wattage value stored in the predetermined threshold values 112. The processor 502 may provide the one or more predetermined threshold values 112 to the terminal 104. In block 1606, logic flow 1600 may receive, by the processor 502, an indication of a characteristic of an electric signal received from the terminal 104, wherein payment card 102 is powered by the electric signal received from the terminal 104. The characteristic of the power signal may be a voltage of the power signal, a resistance of the power signal, an amperage of the power signal, or a wattage of the power signal. In block 1608, logic flow 1600 may determine, by the processor 502, that the characteristic of the power signal received from the terminal 104 is not equal to the predetermined threshold value 112 associated with the payment card 102. In block 1610, logic flow 1600 may reject, by the processor 502 based on the determination that the characteristic of the power signal received from the terminal is less than the predetermined power characteristic associated with the card, the request from the terminal to provide payment information associated with the contactless card to improve security.

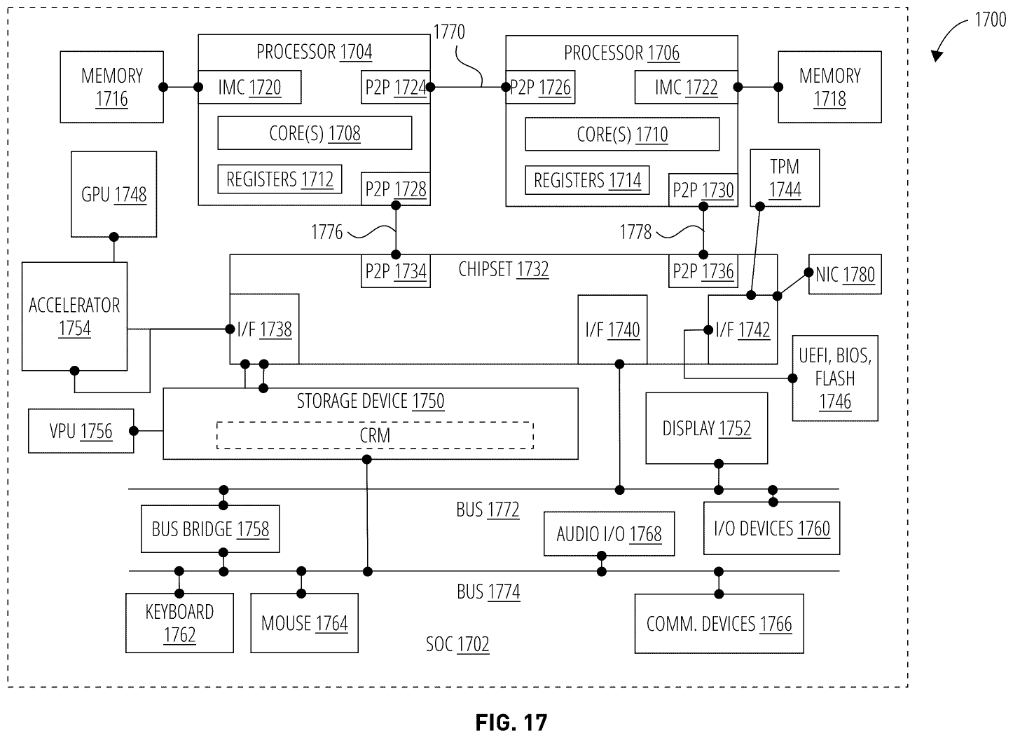

FIG. 17 illustrates an embodiment of a system 1700. System 1700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), an Infrastructure Processing Unit (IPU), a data processing unit (DPU), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 1700 may have a single processor with one core or more than one processor. Note that the term “processor” refers to a processor with a single core or a processor package with multiple processor cores. In at least one embodiment, the computing system 1700 is representative of the components of the terminal 104, client device 202, client 836, server 206, server 302, client server 1084, validator 1088, node 804, merchant system 822, validation system 824, validation node 1308, client server 1084, distributed ledger node 1310, client device 1314, and client node 1302. More generally, the computing system 1700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary system 1700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 17, system 1700 comprises a system-on-chip (SoC) 1702 for mounting platform components. System-on-chip (SoC) 1702 is a point-to-point (P2P) interconnect platform that includes a first processor 1704 and a second processor 1706 coupled via a point-to-point interconnect 1770 such as an Ultra Path Interconnect (UPI). In other embodiments, the system 1700 may be of another bus architecture, such as a multi-drop bus. Furthermore, each of processor 1704 and processor 1706 may be processor packages with multiple processor cores including core(s) 1708 and core(s) 1710, respectively. While the system 1700 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 1704 and chipset 1732. Some platforms may include additional components and some platforms may only include sockets to mount the processors and/or the chipset. Furthermore, some platforms may not have sockets (e.g., SoC, or the like). Although depicted as a SoC 1702, one or more of the components of the SoC 1702 may also be included in a single die package, a multi-chip module (MCM), a multi-die package, a chiplet, a bridge, and/or an interposer. Therefore, embodiments are not limited to a SoC.

The processor 1704 and processor 1706 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 1704 and/or processor 1706. Additionally, the processor 1704 need not be identical to processor 1706.

Processor 1704 includes an integrated memory controller (IMC) 1720 and point-to-point (P2P) interface 1724 and P2P interface 1728. Similarly, the processor 1706 includes an IMC 1722 as well as P2P interface 1726 and P2P interface 1730. IMC 1720 and IMC 1722 couple the processor 1704 and processor 1706, respectively, to respective memories (e.g., memory 1716 and memory 1718). Memory 1716 and memory 1718 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 1716 and the memory 1718 locally attach to the respective processors (e.g., processor 1704 and processor 1706). In other embodiments, the main memory may couple with the processors via a bus and shared memory hub. Processor 1704 includes registers 1712 and processor 1706 includes registers 1714.

System 1700 includes chipset 1732 coupled to processor 1704 and processor 1706. Furthermore, chipset 1732 can be coupled to storage device 1750, for example, via an interface (I/F) 1738. The I/F 1738 may be, for example, a Peripheral Component Interconnect Express (PCIe) interface, a Compute Express Link® (CXL) interface, or a Universal Chiplet Interconnect Express (UCIe) interface. Storage device 1750 can store instructions executable by circuitry of system 1700 (e.g., processor 1704, processor 1706, GPU 1748, accelerator 1754, vision processing unit 1756, or the like).

Processor 1704 couples to the chipset 1732 via P2P interface 1728 and P2P 1734 while processor 1706 couples to the chipset 1732 via P2P interface 1730 and P2P 1736. Direct media interface (DMI) 1776 and DMI 1778 may couple the P2P interface 1728 and the P2P 1734 and the P2P interface 1730 and P2P 1736, respectively. DMI 1776 and DMI 1778 may be a high-speed interconnect that facilitates, e.g., eight Giga Transfers per second (GT/s) such as DMI 3.0. In other embodiments, the processor 1704 and processor 1706 may interconnect via a bus.

The chipset 1732 may comprise a controller hub such as a platform controller hub (PCH). The chipset 1732 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1732 may comprise more than one controller hub such as a chipset with a memory controller hub, a graphics controller hub, and an input/output (I/O) controller hub.

In the depicted example, chipset 1732 couples with a trusted platform module (TPM) 1744 and UEFI, BIOS, FLASH circuitry 1746 via I/F 1742. The TPM 1744 is a dedicated microcontroller designed to secure hardware by integrating cryptographic keys into devices. The UEFI, BIOS, FLASH circuitry 1746 may provide pre-boot code.

Furthermore, chipset 1732 includes the I/F 1738 to couple chipset 1732 with a high-performance graphics engine, such as, graphics processing circuitry or a graphics processing unit (GPU) 1748. In some embodiments, the GPU 1748 is a general purpose GPU (GPGPU). In other embodiments, the system 1700 may include a flexible display interface (FDI) (not shown) between the processor 1704 and/or the processor 1706 and the chipset 1732. The FDI interconnects a graphics processor core in one or more of processor 1704 and/or processor 1706 with the chipset 1732.

The system 1700 is operable to communicate with wired and wireless devices or entities via the network interface controller (NIC) 1780 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE, 5G, 6G wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 1754 and/or vision processing unit 1756 can be coupled to chipset 1732 via I/F 1738. The accelerator 1754 is representative of any type of accelerator device (e.g., a data streaming accelerator, cryptographic accelerator, cryptographic co-processor, neural network accelerator, matrix math accelerator, GPGPU, an offload engine, etc.).

The accelerator 1754 may be a device including circuitry to accelerate copy operations, data encryption, hash value computation, data comparison operations (including comparison of data in memory 1716 and/or memory 1718), and/or data compression. For example, the accelerator 1754 may be a USB device, PCI device, PCIe device, CXL device, UCIe device, and/or an SPI device. The accelerator 1754 can also include circuitry arranged to execute machine learning (ML) related operations (e.g., training, inference, etc.) for ML models. Generally, the accelerator 1754 may be specially designed to perform computationally intensive operations, such as hash value computations, comparison operations, cryptographic operations, and/or compression operations, in a manner that is more efficient than when performed by the processor 1704 or processor 1706. Because the load of the system 1700 may include hash value computations, comparison operations, cryptographic operations, and/or compression operations, the accelerator 1754 can greatly increase performance of the system 1700 for these operations.

The accelerator 1754 may be embodied as any type of device, such as a coprocessor, application-specific integrated circuit (ASIC), field-programmable gate array (FPGA), functional block, IP core, graphics processing unit (GPU), a processor with specific instruction sets for accelerating one or more operations, or other hardware accelerator capable of performing the functions described herein. In some embodiments, the accelerator 1754 may be packaged in a discrete package, an add-in card, a chipset, a multi-chip module (e.g., a chiplet, a dielet, etc.), and/or an SoC. Embodiments are not limited in these contexts.

Various I/O devices 1760 and display 1752 couple to the bus 1772, along with a bus bridge 1758 which couples the bus 1772 to a second bus 1774 and an I/F 1740 that connects the bus 1772 with the chipset 1732. In one embodiment, the second bus 1774 may be a low pin count (LPC) bus. Various devices may couple to the second bus 1774 including, for example, a keyboard 1762, a mouse 1764 and communication devices 1766.

Furthermore, an audio I/O 1768 may couple to second bus 1774. Many of the I/O devices 1760 and communication devices 1766 may reside on the system-on-chip (SoC) 1702 while the keyboard 1762 and the mouse 1764 may be add-on peripherals. In other embodiments, some or all the I/O devices 1760 and communication devices 1766 are add-on peripherals and do not reside on the system-on-chip (SoC) 1702.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to the Figures may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method, comprising:
determining, by a processor of a card, a predetermined voltage associated with the card;
receiving, by the processor, an indication of a voltage received from a terminal, wherein the card is powered at least in part by the voltage received from the terminal;
determining, by the processor, that the voltage received from the terminal is less than the predetermined voltage associated with the card; and
rejecting, by the processor based on the determination that the voltage received from the terminal is less than the predetermined voltage associated with the card, a request from the terminal to provide payment information associated with the card.

2. The method of claim 1, wherein rejecting the request comprises transmitting, by the processor, an error code to the terminal.

3. The method of claim 2, wherein the error code comprises an indication that a skimming device is coupled to the terminal.

4. The method of claim 1, wherein the terminal comprises an automated teller machine (ATM) or a point of sale (POS) device.

5. The method of claim 1, further comprising prior to receiving the indication of the voltage received from the terminal:
transmitting, by the processor to the terminal, an indication of the predetermined voltage associated with the card.

6. The method of claim 1, wherein the indication of the voltage received from the terminal is received from circuitry of the card.

7. The method of claim 1, further comprising prior to determining the predetermined voltage:
receiving, by the processor from the terminal, the request to provide payment information to the terminal.

8. A non-transitory computer-readable storage medium, the computer-readable storage medium including instructions that when executed by a processor of a card, cause the processor to:
determine a predetermined voltage associated with the card;
receive an indication of a voltage received from a terminal, wherein the card is powered at least in part by the voltage received from the terminal;
determine that the voltage received from the terminal is less than the predetermined voltage associated with the card; and
reject, based on the determination that the voltage received from the terminal is less than the predetermined voltage associated with the card, a request from the terminal to provide payment information associated with the card.

9. The non-transitory computer-readable storage medium of claim 8, wherein the instructions to reject the request comprise instructions to transmit an error code to the terminal.

10. The non-transitory computer-readable storage medium of claim 9, wherein the error code comprises an indication that a skimming device is coupled to the terminal.

11. The non-transitory computer-readable storage medium of claim 8, wherein the instructions further cause the processor to, prior to receiving the indication of the voltage received from the terminal:
transmit, to the terminal, an indication of the predetermined voltage associated with the card.

12. The non-transitory computer-readable storage medium of claim 8, wherein the indication of the voltage is stored in the medium.

13. The non-transitory computer-readable storage medium of claim 8, wherein the instructions further cause the processor to:
receive an updated voltage value; and
store the updated voltage value as the predetermined voltage in the medium.

14. The non-transitory computer-readable storage medium of claim 8, wherein the instructions further cause the processor to, prior to determining the predetermined voltage:
receive, from the terminal, the request to provide payment information to the terminal.

15. A card, comprising:
a processor; and
a memory storing instructions that, when executed by the processor, cause the processor to:
determine a predetermined power characteristic associated with the card;
receive an indication of a characteristic of a power signal received from a terminal, wherein the card is powered at least in part by the power signal received from the terminal;
determine that the characteristic of the power signal does not equal the predetermined power characteristic associated with the card; and
reject, based on the determination that the characteristic of the power signal does not equal the predetermined power characteristic associated with the card, a request from the terminal to provide payment information associated with the card.

16. The card of claim 15, wherein the predetermined power characteristic comprises one or more of a predetermined voltage value, a predetermined wattage value, a predetermined time threshold, or a predetermined amperage value, wherein the characteristic of the power signal comprises one or more of a voltage of the power signal, a wattage of the power signal, a time duration of the power signal, or an amperage of the power signal.

17. The card of claim 15, wherein the instructions to reject the request comprise instructions to transmit an error code to the terminal, wherein the error code comprises an indication that a skimming device is coupled to the terminal.

18. The card of claim 15, wherein the instructions further cause the processor to, prior to receiving the indication of the characteristic of the power signal:
transmit, to the terminal, an indication of the predetermined power characteristic associated with the card.

19. The card of claim 15, wherein the predetermined power characteristic is stored in the memory.

20. The card of claim 19, wherein the instructions further cause the processor to:
receive an updated power characteristic; and
store the updated power characteristic as the predetermined power characteristic.
